(19) United States
(12) Patent Application Publication
(10) Pub. No.: US 2026/0302304 A1
(43) Pub. Date: Oct. 1, 2026

(54) MANIFOLD INSERT FOR AN ELECTROCHEMICAL SYSTEM

(71) Applicant: NEW HYDROGEN IP, LLC, Columbus, IN (US)

(72) Inventors: Jean ST-PIERRE, Indianapolis, IN (US); Arun P. JANAKIRAMAN, Bargersville, IN (US)

(21) Appl. No.: 19/543,629

(22) Filed: Feb. 18, 2026

Related U.S. Application Data
(60) Provisional application No. 63/777,245, filed on Mar. 25, 2025.

(51) Int. Cl. H01M 8/2483; C25B 9/75; C25B 9/77; C25B 15/08; H01M 8/0258; H01M 8/0273; H01M 8/2404

(52) U.S. Cl. CPC H01M 8/2483; C25B 9/75; C25B 9/77; C25B 15/08; H01M 8/0258; H01M 8/0273; H01M 8/2404

(57) ABSTRACT

An electrochemical system includes a plurality of electrochemical cells, a first inlet port, and a first manifold insert. The first inlet port is configured to direct a first fluid into a first continuous inlet manifold formed by the plurality of electrochemical cells. The first manifold insert is removably positioned in the first continuous inlet manifold to provide flow resistance for the first fluid in the first continuous inlet manifold thereby producing a more uniform flow distribution to each of the plurality of electrochemical cells.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Serial No. 63/777,245 filed on Mar. 25, 2025, the entire disclosure of which is hereby expressly incorporated herein by reference.

### TECHNICAL FIELD

The present disclosure relates to a manifold insert for use in an electrochemical system and methods of using the manifold insert.

### BACKGROUND

Fuel cell systems are known for their efficient use of fuel to produce direct current electric energy to power mobile applications, such as, for example, vehicles, trains, buses, and trucks. Electrolyzer systems are known for their efficient use of water and electricity to produce hydrogen and oxygen. Fuel cell systems and electrolyzer systems may experience non-uniform reactant, product, and/or coolant flow. Non-uniform flow may decrease performance or efficiency of the systems or result in damage to the systems. Thus, it may be advantageous to provide for more uniform reactant, product, and/or coolant flow within fuel cell systems and electrolyzer systems.

The present disclosure is directed to a manifold insert for use in an electrochemical system and methods of using the manifold insert to provide for a more uniform flow.

### SUMMARY

Embodiments of the present disclosure are included to meet these and other needs.

In one aspect described herein, an electrochemical system comprises a plurality of electrochemical cells, a first inlet port, and a first manifold insert. The plurality of electrochemical cells are assembled together to form a stack. Each of the plurality of electrochemical cells have a membrane, a first bipolar plate arranged on a first side of the membrane, and a second bipolar plate arranged on a second side of the membrane opposite the first side. Each of the first and second bipolar plates are formed to include a first manifold aligned with one another to define a first continuous inlet manifold in fluid communication with first flow fields of the first bipolar plate or the second bipolar plate. The first inlet port is configured to direct a first fluid into the first continuous inlet manifold. The first continuous inlet manifold extends between a first terminal end at the first inlet port and a second terminal end opposite the first terminal end. The first manifold insert is removably positioned in the first continuous inlet manifold to provide flow resistance for the first fluid in the first continuous inlet manifold thereby producing a more uniform flow distribution to the first flow fields of the first bipolar plate or the second bipolar plate of each of the plurality of electrochemical cells.

In some embodiments, the first manifold insert may vary an area of the first continuous inlet manifold as the first continuous inlet manifold extends from the first terminal end to the second terminal end. In some embodiments, the first inlet manifold may be wedge shaped. In some embodiments, the area of the first continuous inlet manifold may increase due to the first manifold insert as the first continuous inlet manifold extends from the first terminal end to the second terminal end.

In some embodiments, each of the first and second bipolar plates may be further formed to include a second manifold aligned with one another to define a second continuous inlet manifold in fluid communication with second flow fields of the first bipolar plate or the second bipolar plate. In some embodiments, the electrochemical system may further include a second inlet port configured to direct a second fluid into the second continuous inlet manifold and a second manifold insert. In some embodiments, the second continuous inlet manifold may extend between a first terminal end at the second inlet port and a second terminal end opposite the first terminal end. In some embodiments, the second manifold insert may be removably positioned in the second continuous inlet manifold to provide flow resistance for the second fluid in the second continuous inlet manifold thereby producing a more uniform flow distribution to the second flow fields of the first bipolar plate or the second bipolar plate of each of the plurality of electrochemical cells.

In some embodiments, the first manifold insert may include a frame and a plurality of baffles coupled to the frame in spaced apart relation to one another. In some embodiments, the plurality of baffles may deflect flow of the first fluid away from the first flow fields before the first fluid is directed into the first flow fields. In some embodiments, the first manifold insert may include a plate having a plurality of holes formed therein. In some embodiments, a permeability of the plate may vary as the first continuous inlet manifold extends from the first terminal end to the second terminal end. In some embodiments, the permeability of the plate may increase as the first continuous inlet manifold extends from the first terminal end to the second terminal end.

In some embodiments, the first manifold insert may include a woven screen having a plurality of pores formed therein. In some embodiments, a permeability of the woven screen may vary as the first continuous inlet manifold extends from the first terminal end to the second terminal end.

According to a second aspect, described herein, an electrochemical system comprises a plurality of electrochemical cells, a first inlet port, and a first manifold insert. The plurality of electrochemical cells are assembled together to form a stack. Each of the plurality of electrochemical cells have a first manifold aligned with the first manifold of adjacent electrochemical cells to define a first continuous inlet manifold in fluid communication with first flow fields of each of the plurality of electrochemical cells. The first inlet port is configured to direct a first fluid into the first continuous inlet manifold. The first manifold insert is removably positioned in the first continuous inlet manifold to provide flow resistance for the first fluid in the first continuous inlet manifold thereby producing a more uniform flow distribution to the first flow fields of each of the plurality of electrochemical cells.

In some embodiments, the first continuous inlet manifold may extend between a first terminal end at the first inlet port and a second terminal end opposite the first terminal end. In some embodiments, the first manifold insert may vary an area of the first continuous inlet manifold as the first continuous inlet manifold extends from the first terminal end to the second terminal end. In some embodiments, the first inlet manifold may be wedge shaped so as to have a first height adjacent the first terminal end and a second height adjacent the second terminal end. In some embodiments, the first height may be greater than the second height.

In some embodiments, the first manifold insert may include a frame and a plurality of baffles coupled to the frame in spaced apart relation to one another. In some embodiments, the plurality of baffles may deflect flow of the first fluid away from the first flow fields before the first fluid is directed into the first flow fields. In some embodiments, the first continuous inlet manifold may extend between a first terminal end at the first inlet port and a second terminal end opposite the first terminal end. In some embodiments, the first manifold insert may include a plate having a plurality of holes formed therein. In some embodiments, permeability of the plate may vary as the first continuous inlet manifold extends from the first terminal end to the second terminal end.

In some embodiments, the first continuous inlet manifold may extend between a first terminal end at the first inlet port and a second terminal end opposite the first terminal end. In some embodiments, the first manifold insert may include a woven screen having a plurality of pores formed therein. In some embodiments, a permeability of the woven screen may vary as the first continuous inlet manifold extends from the first terminal end to the second terminal end.

According to a third aspect, described herein, a method comprises stacking a plurality of electrochemical cells adjacent one another such that a first manifold of each of the plurality of electrochemical cells is aligned with one another to form a first continuous inlet manifold, inserting a manifold insert into the first continuous inlet manifold, directing fluid into the first continuous inlet manifold from an inlet port, and variably restricting flow of the fluid within the first continuous inlet manifold via the manifold insert to cause uniform distribution of the fluid to each of the plurality of electrochemical cells.

In some embodiments, the method may further comprise removing the manifold insert from the first continuous inlet manifold, and, after the step of removing, inserting a different manifold insert into the first continuous inlet manifold. In some embodiments, the step of variably restricting flow may include having a first flow resistance adjacent the inlet port and having a second flow resistance opposite the inlet port. In some embodiments, the second flow resistance may be less than the first flow resistance.

In some embodiments, the step of stacking may include aligning a second manifold of each of the plurality of electrochemical cells with one another to form a second continuous outlet manifold. In some embodiments, the method may further comprise directing the fluid through the first continuous inlet manifold, through the plurality of electrochemical cells, and then into the second continuous outlet manifold. In some embodiments, the method may further comprise inserting a second manifold insert into the second continuous outlet manifold.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A is perspective view of an electrolyzer cell stack according to the present disclosure;

FIG. 2B is a schematic view of an electrolysis system configured to utilize the electrolyzer cell stack of FIG. 2A;

FIG. 2C is a schematic view of an additional portion of the electrolysis system of FIG. 2B;

FIG. 3 is a perspective view of a fuel cell stack having reactant flow paths and a coolant flow path;

FIG. 4 is a diagrammatic view of a U-type flow path through the fuel cell stack;

FIG. 5 is a diagrammatic view of a Z-type flow path through the fuel cell stack;

FIG. 6 is a top view of a bipolar plate of the fuel cell stack of FIG. 3 showing that the bipolar plate is formed to include a plurality of manifolds to receive the reactants and the coolant therein;

FIG. 7 is an exploded diagrammatic view of an electrochemical system including the fuel cell stack of FIG. 3 and at least one manifold insert configured to extend into manifolds of fuel cells included in the fuel cell stack to provide a more uniform flow of reactants and/or coolant to the fuel cells;

FIG. 8 is a diagrammatic view of the electrochemical system of FIG. 7 with the at least one manifold insert extending through the manifolds of the fuel cells;

FIG. 9 is an exploded diagrammatic view of an electrochemical system including the fuel cell stack of FIG. 3 and an alternative manifold insert configured to extend into manifolds of fuel cells included in the fuel cell stack to provide a more uniform flow of reactants and/or coolant to the fuel cells;

FIG. 10 is a diagrammatic view of the electrochemical system of FIG. 9 with the at least one manifold insert extending through the manifolds of the fuel cells;

FIG. 11 is a diagrammatic view of an electrochemical system including the fuel cell stack of FIG. 3 and an alternative manifold insert extending into manifolds of fuel cells included in the fuel cell stack to provide a more uniform flow of reactants and/or coolant to the fuel cells;

FIG. 12 is an enlarged diagrammatic view of the manifold insert of FIG. 11 located in the manifolds;

FIG. 13 is a perspective view of the manifold insert of FIG. 11 showing that the manifold insert is formed as a plate having a plurality of holes therein;

FIG. 14 is a perspective view of an alternative manifold insert for use with the electrochemical system of FIG. 11, the manifold insert formed as a porous screen;

FIG. 15 is a graph showing inlet manifold mass flow distributions with various plates of FIG. 13 compared to the inlet manifold mass flow distribution without a plate;

FIG. 16 is a simplified graph of FIG. 15 showing the baseline flow distribution without the plate and the flow distribution for one plate;

FIG. 17 shows flow path lines and permeability variation for the plate of FIG. 16;

FIG. 18 is a graph showing inlet manifold mass flow distributions with various porous screens of FIG. 14 compared to the inlet manifold mass flow distribution without a porous screen;

FIG. 19 is a simplified graph of FIG. 18 showing the baseline flow distribution without the porous screen and the flow distributions for two different porous screens;

FIG. 20 shows flow path lines and permeability variation for one of the porous screens of FIG. 19;

FIG. 21 shows a top view of an electrochemical stack;

FIG. 21A shows a cross-section view of the electrochemical stack of FIG. 21; and

FIG. 21B shows another cross-section view of the electrochemical stack of FIG. 21.

### DETAILED DESCRIPTION

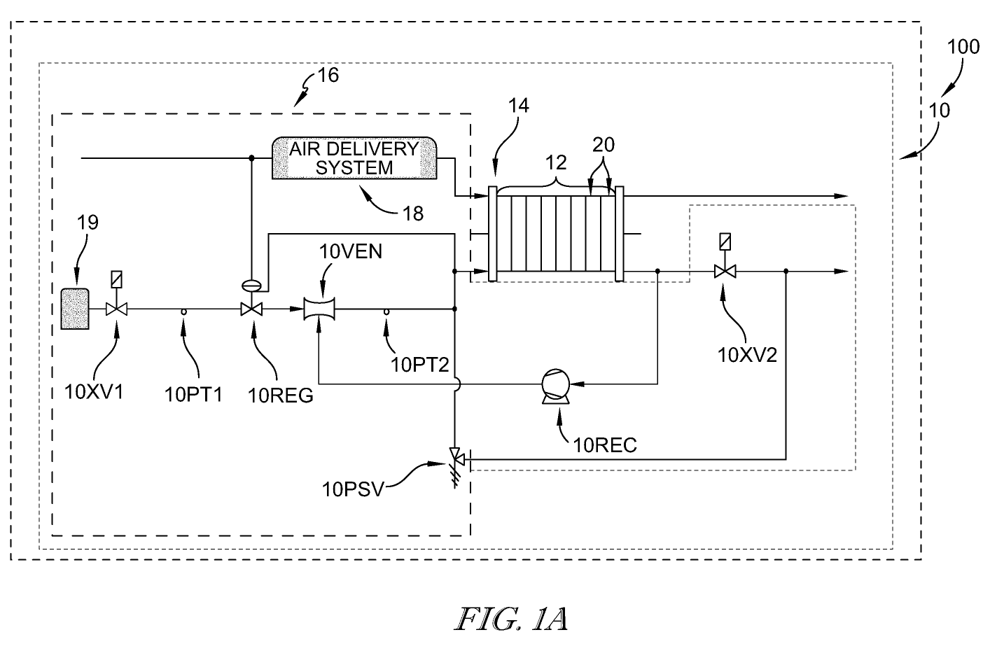

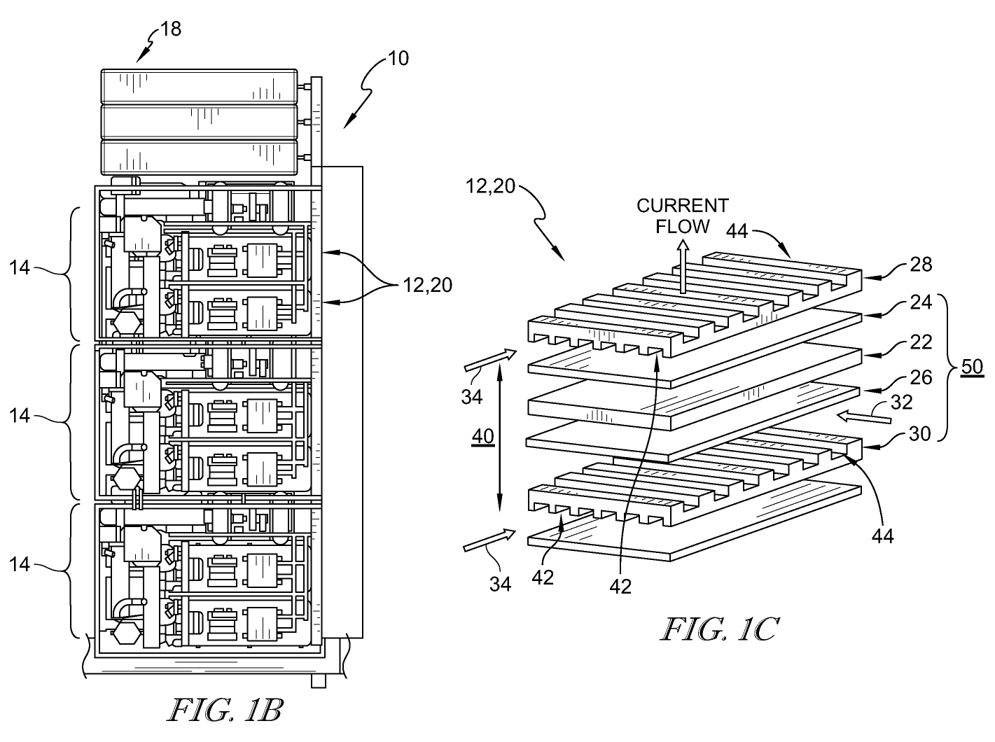

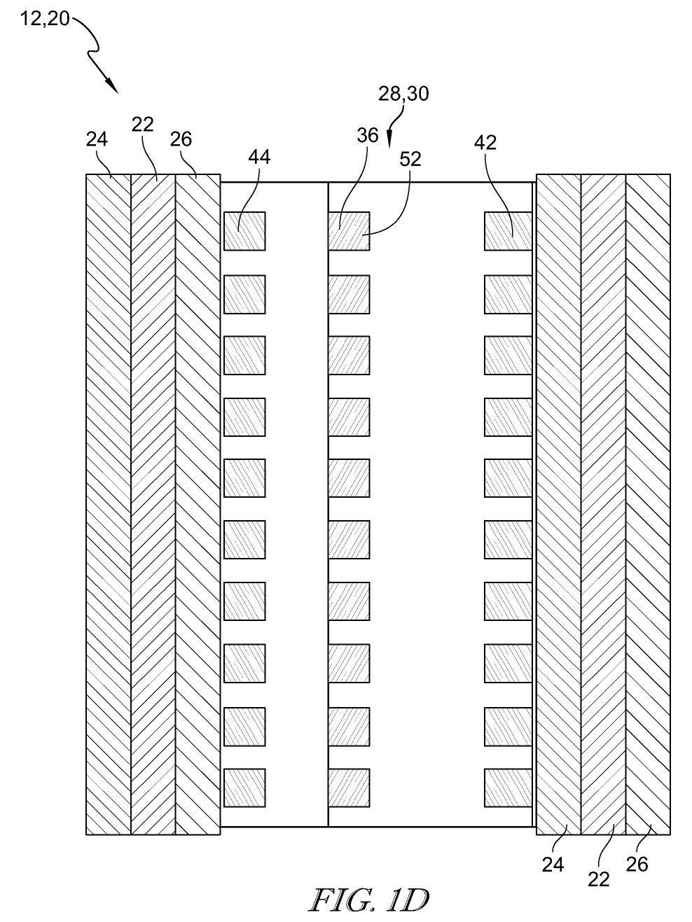

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B. In some embodiments, the fuel cell system 10 may comprise one or more fuel cell stacks 12.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling liquid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plates (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26. The bipolar plate (BPP) 28, 30 also includes oxidant flow fields 42 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling liquid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19, as shown in FIG. 1A. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV, as shown in FIG. 1A.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a passenger car, a bus, a truck, a train, a locomotive, an aircraft, a light duty vehicle, a medium duty vehicle, or a heavy-duty vehicle. Types of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

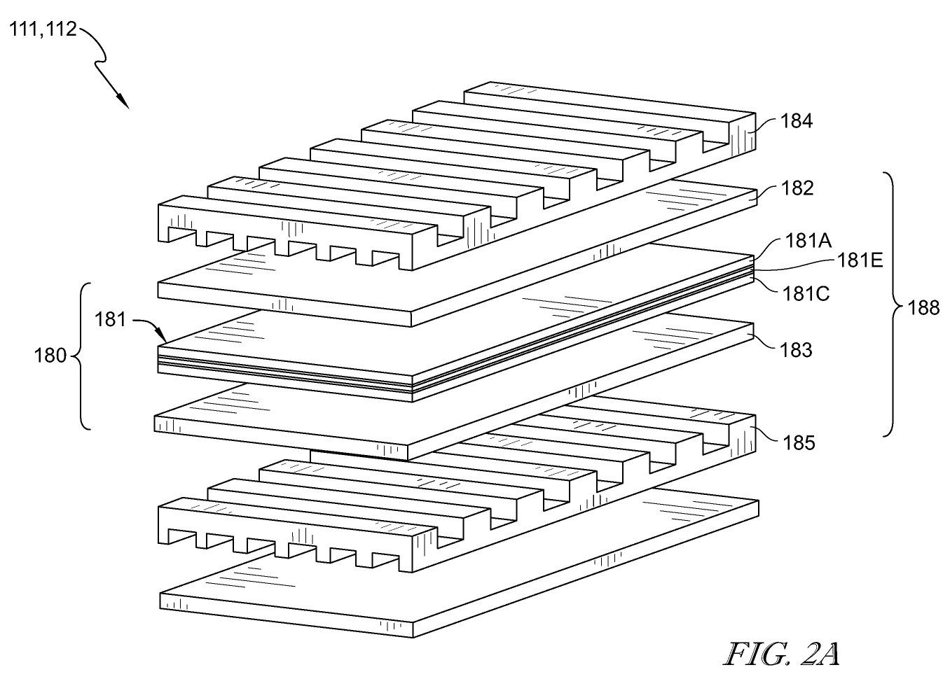

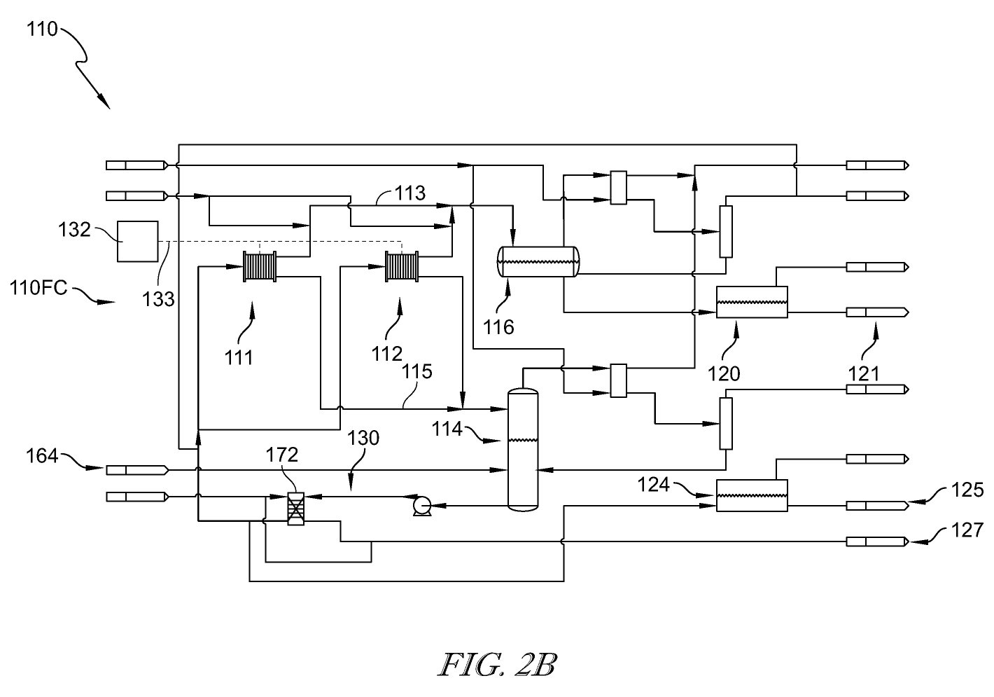

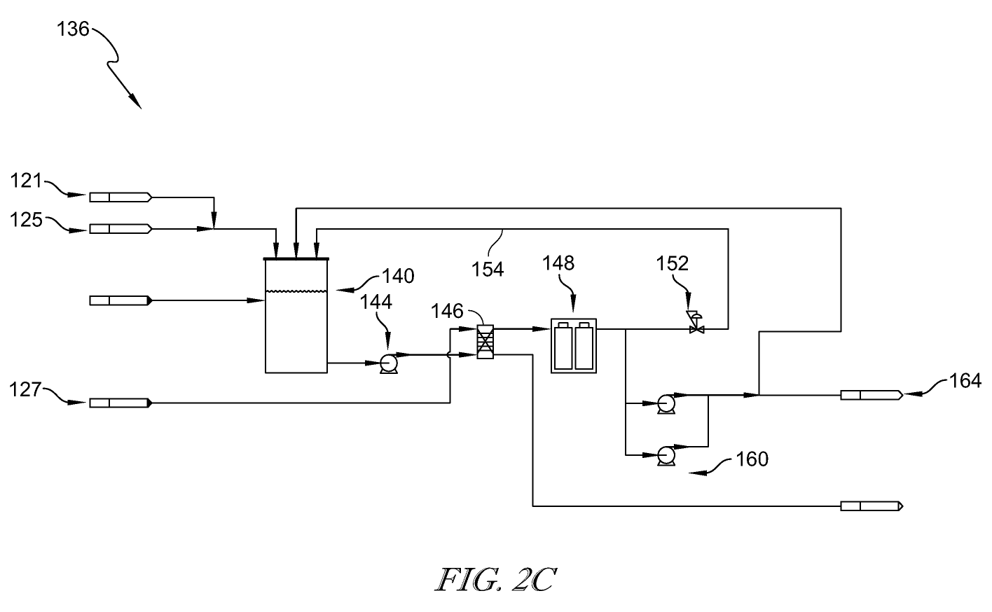

As shown in FIGS. 2A and 2B, electrolysis systems 110 are typically configured to utilize water and electricity to produce hydrogen and oxygen. An electrolysis system 110 typically includes one or more electrolyzer cells 180 that utilize electricity to chemically produce substantially pure hydrogen 113 and oxygen 115 from deionized water 130. Often the electrical source for the electrolysis systems 110 is produced from power or energy generation systems, including renewable energy systems such as wind, solar, hydroelectric, and geothermal sources for the production of green hydrogen. In turn, the pure hydrogen produced by the electrolysis systems 110 is often utilized as a fuel or energy source for those same power generation systems, such as fuel cell systems. Alternatively, the pure hydrogen produced by the electrolysis systems 110 may be stored for later use.

The typical electrolyzer cell 180, or electrolytic cell, is comprised of multiple assemblies compressed and bound into a single assembly, and multiple electrolyzer cells 180 may be stacked relative to each other, along with bipolar plates (BPP) 184, 185 therebetween, to form an electrolyzer cell stack (for example, electrolyzer cell stacks 111, 112 in FIG. 2B). Each electrolyzer cell stack 111, 112 may house a plurality of electrolyzer cells 180 connected together in series and/or in parallel. The number of electrolyzer cell stacks 111, 112 in the electrolysis systems 110 can vary depending on the amount of power required to meet the power need of any load (e.g., fuel cell stack). The number of electrolyzer cells 180 in an electrolyzer cell stack 111, 112 can vary depending on the amount of power required to operate the electrolysis systems 110 including the electrolyzer cell stack 111, 112.

An electrolyzer cell 180 includes a multi-component membrane electrode assembly (MEA) 181 that has an electrolyte 181E, an anode 181A, and a cathode 181C. Typically, the anode 181A, cathode 181C, and electrolyte 181E of the membrane electrode assembly (MEA) 181 are configured in a multi-layer arrangement that enables the electrochemical reaction to produce hydrogen and/or oxygen via contact of the water with one or more gas diffusion layers 182, 183. The gas diffusion layers (GDL) 182, 183, which may also be referred to as porous transport layers (PTL), are typically located on one or both sides of the MEA 181. Bipolar plates (BPP) 184, 185 often reside on either side of the GDLs and separate the individual electrolyzer cells 180 of the electrolyzer cell stack 111, 112 from one another. One bipolar plate 185 and the adjacent gas diffusion layers 182, 183 and MEA 181 can form a repeating unit 188.

As shown in FIGS. 2B and 2C, an exemplary electrolysis system 110 can include two electrolyzer cell stacks 111, 112 and a fluidic circuit 110FC including the various fluidic pathways shown in FIGS. 2B and 2C that is configured to circulate, inject, and purge fluid and other components to and from the electrolysis systems 110. A person skilled in the art would understand that one or a variety of a number of components within the fluidic circuit 110FC, as well as more or less than two electrolyzer cell stacks 111, 112, may be utilized in the electrolysis systems 110. For example, the electrolysis systems 110 may include one electrolyzer cell stack 111, and in other examples, the electrolysis systems 110 may include three or more electrolyzer cell stacks.

The electrolysis systems 110 may include one or more types of electrolyzer cell stacks 111, 112 therein. In the illustrated embodiment, a polymer electrolyte membrane (PEM) electrolyzer cell 180 may be utilized in the stacks 111, 112. A PEM electrolyzer cell 180 typically operates at about 4^{o}C to about 150^{o}C, including any specific or range of temperatures comprised therein. A PEM electrolyzer cell 180 also typically functions at about 100 bar or less, but can go up to about 1000 bar (including any specific or range of pressures comprised therein), which reduces the total energy demand of the system. A standard electrochemical reaction that occurs in a PEM electrolyzer cell 180 to produce hydrogen is as follows.

Anode: 2H2O → O2 + 4H+ + 4e

Cathode: 4H+ + 4e– → 2H2

Overall: 2H2O (liquid) → 2H2 + O2

Additionally, a solid oxide electrolyzer cell 180 may be utilized in the electrolysis systems 110. A solid oxide electrolyzer cell 180 will function at about 500^{o}C to about 1000^{o}C, including any specific or range of temperatures comprised therein. A standard electrochemical reaction that occurs in a solid oxide electrolyzer cell 180 to produce hydrogen is as follows.

Anode: 2O2– → O2 + 4e

Cathode: 2H2O + 4e– → 2H2 + 2O2

Overall: 2H2O (liquid/vapor) → 2H2 + O2

Moreover, an AEM electrolyzer cell 180 may be utilized, which uses an alkaline media. An exemplary AEM electrolyzer cell 180 is an alkaline electrolyzer cell 180. Alkaline electrolyzer cells 180 comprise aqueous solutions, such as potassium hydroxide (KOH) and/or sodium hydroxide (NaOH), as the electrolyte. Alkaline electrolyzer cells 180 typically perform at operating temperatures ranging from about 0^{o}C to about 150^{o}C, including any specific or range of temperatures comprised therein. Alkaline electrolyzer cells 180 generally operate at pressures ranging from about 1 bar to about 100 bar, including any specific or range of pressures comprised therein. A typical hydrogen-generating electrochemical reaction that occurs in an alkaline electrolyzer cell 180 is as follows.

Anode: 4OH– → O2 + 2H2O + 4e

Cathode: 4H2O + 4e– → 2H2 + 4OH

Overall: 2H2O → 2H2 + O2

As shown in FIG. 2B, the electrolyzer cell stacks 111, 112 include one or more electrolyzer cells 180 that utilize electricity to chemically produce substantially pure hydrogen and oxygen from water. In turn, the pure hydrogen produced by the electrolyzer may be utilized as a fuel or energy source. As shown in FIG. 2B, the electrolyzer cell stack 111, 112 outputs the produced hydrogen along a fluidic connecting line 113 to a hydrogen separator 116, and also outputs the produced oxygen along a fluidic connecting line 115 to an oxygen separator 114.

The hydrogen separator 116 may be configured to output pure hydrogen gas and also send additional output fluid to a hydrogen drain tank 120, which then outputs fluid to a deionized water drain 121. The oxygen separator 114 may output fluid to an oxygen drain tank 124, which in turn outputs fluid to a deionized water drain 125. A person skilled in the art would understand that certain inputs and outputs of fluid may be pure water or other fluids such as coolant or byproducts of the chemical reactions of the electrolyzer cell stacks 111, 112. For example, oxygen and hydrogen may flow away from the cell stacks 111, 112 to the respective separators 114, 116. The system 110 may further include a rectifier 132 configured to convert electricity 133 flowing to the cell stacks 111, 112 from alternating current (AC) to direct current (DC).

The deionized water drains 121, 125 each output to a deionized water tank 140, which is part of a polishing loop 136 of the fluidic circuit 110FC, as shown in FIG. 2C. Water with ion content can damage electrolyzer cell stacks 111, 112 when the ionized water interacts with internal components of the electrolyzer cell stacks 111, 112. The polishing loop 136, shown in greater detail in FIG. 2C, is configured to deionize the water such that it may be utilized in the cell stacks 111, 112 and not damage the cell stacks 111, 112.

In the illustrated embodiment, the deionized water tank 140 outputs fluid, in particular water, to a deionized water polishing pump 144. The deionized water polishing pump 144 in turn outputs the water to a water polishing heat exchanger 146 for polishing and treatment. The water then flows to a deionized water resin tank 148.

Coolant is directed through the electrolysis systems 110, in particular through a deionized water heat exchanger 172 that is fluidically connected to the oxygen separator 114. The coolant used to cool said water may also be subsequently fed to the water polishing heat exchanger 146 via a coolant input 127 for polishing. The coolant is then output back to the deionized water heat exchanger 172 for cooling the water therein.

After the water is output from the deionized water polishing heat exchanger 146 and subsequently to the deionized water resin tank 148, a portion of the water may be fed to deionized water high pressure feed pumps 160. Another portion of the water may be fed to a deionized water pressure control valve 152, as shown in FIG. 2C. The portion of the water that is fed to the deionized water pressure control valve 152 flows through a recirculation fluidic connection 154 that allows the water to flow back to the deionized water tank 140 for continued polishing.

In some embodiments, the electrolysis systems 110 may increase deionized water skid for polishing water flow to flush out ions within the water at a faster rate. The portion of the water that is fed to the deionized water high pressure feed pumps 160 is then output to a deionized water feed 164, which then flows into the oxygen separator 114 for recirculation and eventual reusage in the electrolyzer cell stacks 111, 112. This process may then continuously repeat.

The electrolysis systems 110 described herein may be used in stationary and/or immovable power system, such as industrial applications and power generation plants. The electrolysis systems 110 may also be implemented in conjunction with other electrolysis systems 110.

The present electrolysis systems 110 may be comprised in mobile applications. The electrolysis systems 110 may be in the vehicle or the powertrain 100. The vehicle or powertrain 100 comprising the electrolysis systems 110 may be an automobile, a pass car, a bus, a truck, a train, a locomotive, an aircraft, a light duty vehicle, a medium duty vehicle, or a heavy-duty vehicle.

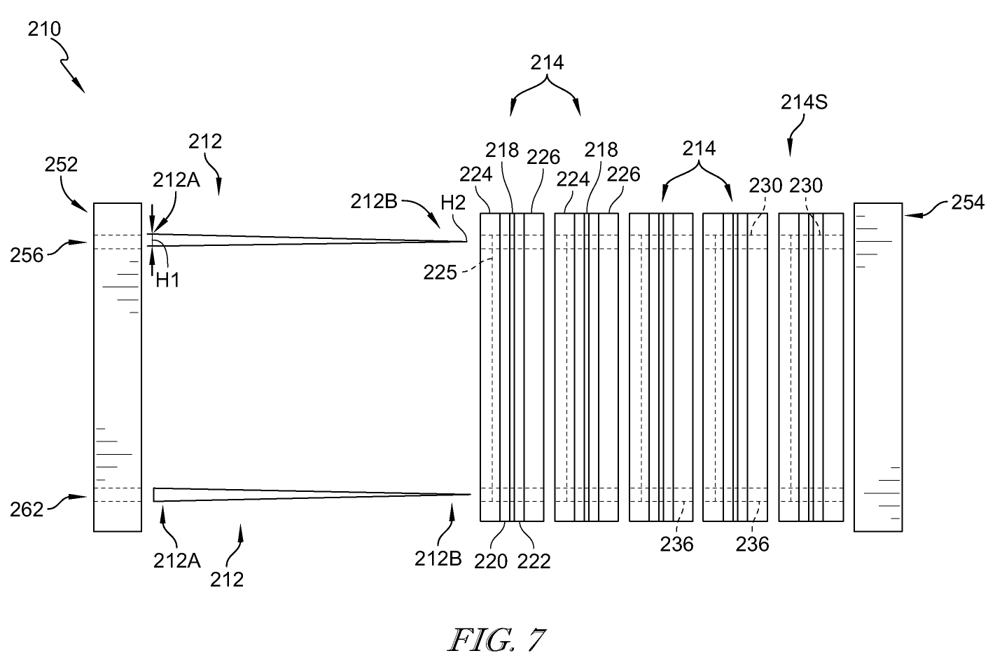

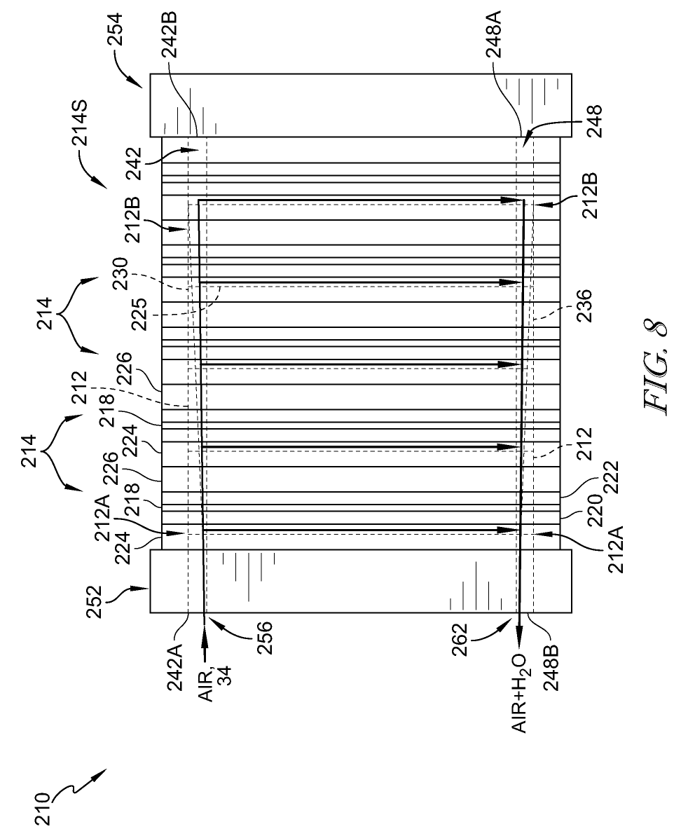

The present disclosure provides a manifold insert 212 for an electrochemical system 210, as shown in FIGS. 7 and 8. The manifold insert 212 provides a more uniform flow distribution to electrochemical cells 214 of the electrochemical system 210. The electrochemical system 210 includes the plurality of electrochemical cells 214, a first inlet port 216, and the manifold insert 212.

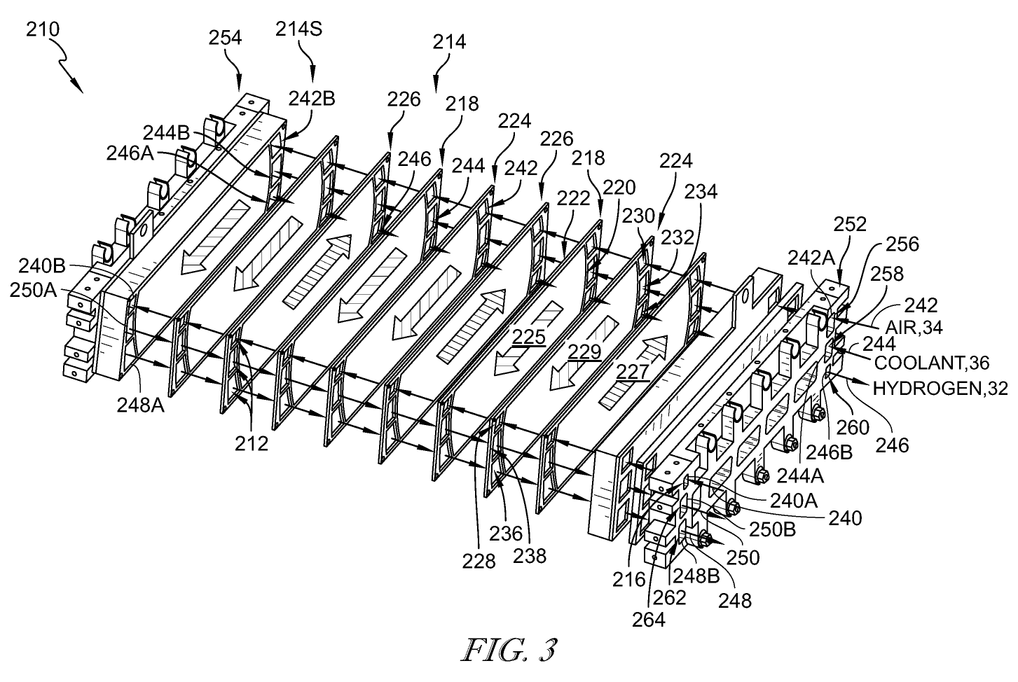

Each of the electrochemical cells 214 includes a membrane electrode assembly (MEA) 218, gas diffusion layers 220, 222, and bipolar plates 224, 226, as shown in FIG. 3. The gas diffusion layers 220, 222 are located on either side of the MEA 218. The bipolar plates 224, 226 are located on either side of the gas diffusion layers 220, 222. The electrochemical cells 214 are stacked with one another to form an electrochemical stack 214S, as suggested in FIG. 3.

The MEA 218 may be the MEA 22 or the MEA 181, as described above. The gas diffusion layers 220, 222 may be the gas diffusion layers 24, 26, 182, 183, as described above. The bipolar plates 224, 226 may be the bipolar plates 28, 30, 184, 185, as described above. The electrochemical cell 214 may be the fuel cell 20 or the electrolyzer cell 180, as described above.

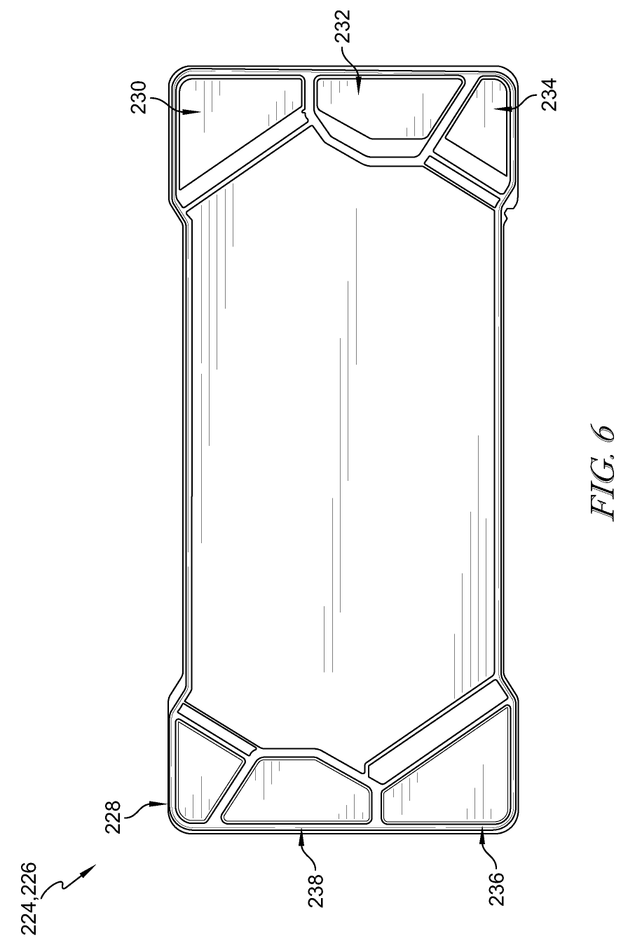

As shown in FIGS. 3 and 6, each of the MEA 218 and the bipolar plates 224, 226 include a first manifold 228, a second manifold 230, a third manifold 232, a fourth manifold 234, a fifth manifold 236, and a sixth manifold 238. The first manifold 228, the sixth manifold 238, and the fifth manifold 236 are located on a first side of the MEA 218 and the bipolar plates 224, 226. The second manifold 230, the third manifold 232, and the fourth manifold 234 are located on a second side of the MEA 218 and the bipolar plates 224, 226.

After the components of the electrochemical cells 214 are stacked together, the first manifold 228 of each of the MEA 218 and the bipolar plates 224, 226 are aligned with one another to form a first continuous inlet manifold 240. Likewise, the second manifold 230 of each of the MEA 218 and the bipolar plates 224, 226 are aligned with one another to form a second continuous inlet manifold 242, and the third manifold 232 of each of the MEA 218 and the bipolar plates 224, 226 are aligned with one another to form a third continuous inlet manifold 244. Additionally, the fourth manifold 234 of each of the MEA 218 and the bipolar plates 224, 226 are aligned with one another to form a first continuous outlet manifold 246. The fifth manifold 236 of each of the MEA 218 and the bipolar plates 224, 226 are aligned with one another to form a second continuous outlet manifold 248. The sixth manifold 238 of each of the MEA 218 and the bipolar plates 224, 226 are aligned with one another to form a third continuous outlet manifold 250.

Fluids 32, 34, 36 are directed into the continuous inlet manifolds 240, 242, 244 and then fed into active areas of the bipolar plates 224, 226, as shown in FIG. 3. From the active areas of the bipolar plates 224, 226, the fluids 32, 34, 36 are directed into the continuous outlet manifolds 246, 248, 250. As an example, a reactant 34, such as an oxidant (i.e., air) may be directed through the second continuous inlet manifold 242, into oxidant flow fields 225 formed in the bipolar plates 224, 226, and then out of the second continuous outlet manifold 248. As another example, a reactant 32, such as a fuel (i.e., hydrogen) may be directed through the first continuous inlet manifold 240, into fuel flow fields 227 formed in the bipolar plates 224, 226, and then out of the first continuous outlet manifold 246. As another example, a cooling liquid 36 may be directed through the third continuous inlet manifold 244, into coolant flow fields 229 formed in the bipolar plates 224, 226, and then out of the third continuous outlet manifold 250.

The electrochemical system 210 further includes a first endplate 252 and a second endplate 254 spaced apart from the first endplate 252, as shown in FIGS. 3 and 7. The electrochemical stack 214S is located between the endplates 252, 254. The first inlet port 216 is formed in the first endplate 252, as shown in FIG. 3. The first inlet port 216 is in fluid communication with the first continuous inlet manifold 240 to direct the fuel 32 thereto.

In some embodiments, the first endplate 252 is further formed to include a second inlet port 256 and a third inlet port 258, as shown in FIG. 3. The second inlet port 256 is in fluid communication with the second continuous inlet manifold 242 to direct the oxidant 34 thereto. The third inlet port 258 is in fluid communication with the third continuous inlet manifold 244 to direct the cooling liquid 36 thereto.

In some embodiments, the first endplate 252 is further formed to include a first outlet port 260, a second outlet port 262, and/or a third outlet port 264, as shown in FIG. 3. The first outlet port 260 is in fluid communication with the first continuous outlet manifold 246 to receive the fuel 32 therefrom. The second outlet port 262 is in fluid communication with the second continuous outlet manifold 248 to receive the oxidant 34 therefrom. The third outlet port 264 is in fluid communication with the third continuous outlet manifold 250 to receive the cooling liquid 36 therefrom.

A person skilled in the art will understand that different manifold arrangements may be formed, different inlet and outlet arrangements may be formed, and different fluids may be directed through the different manifolds.

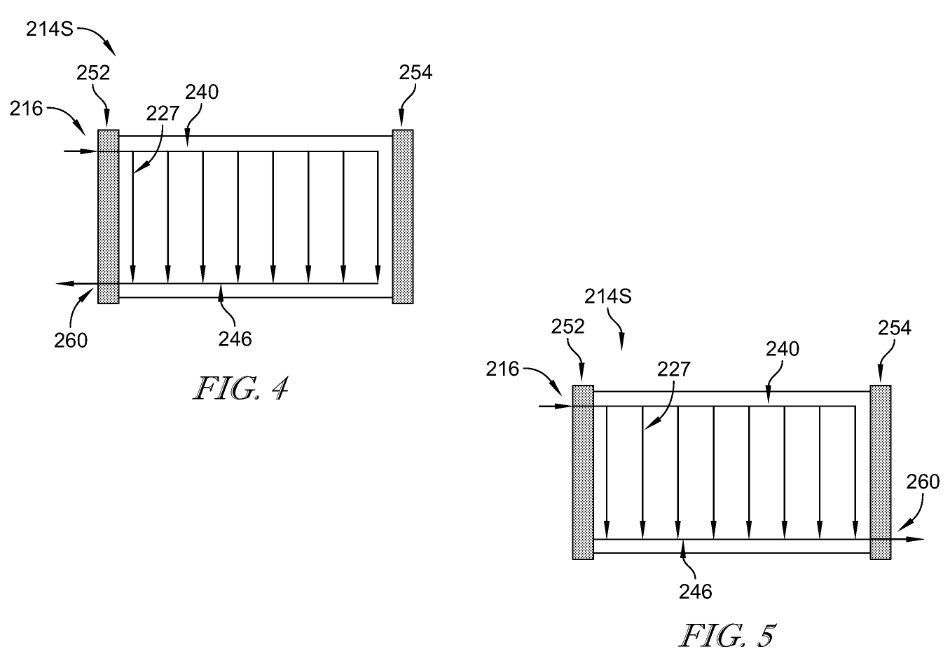

FIGS. 3 and 4 show U-type manifolds with the inlet ports 216, 256, 258 and the outlet ports 260, 262, 264 formed in the first endplate 252. In some embodiments, the electrochemical system 210 may use Z-type manifolds, as shown in FIG. 5. In Z-type manifolds, the inlet ports 216, 256, 258 are formed in the first endplate 252, and the outlet ports 260, 262, 264 are formed in the second endplate 254. U-type manifolds may be preferred based on packaging considerations.

As shown in FIGS. 3, 7, and 8, each of the continuous inlet manifolds 240, 242, 244 extends between a first terminal end 240A, 242A, 244A at the inlet port 216, 256, 258 and a second terminal end 240B, 242B, 244B opposite the first terminal end 240A, 242A, 244A. The second terminal end 240B, 242B, 244B is located adjacent the second endplate 254.

Each of the continuous outlet manifolds 246, 248, 250 extends between a first terminal end 246A, 248A, 250A adjacent the second endplate 254 and a second terminal end 246B, 248B, 250B opposite the first terminal end 246A, 248A, 250A. The second terminal end 246B, 248B, 250B is located at the outlet port 260, 262, 264.

As shown in FIGS. 3 and 4, the fluids 32, 34, 36 are supplied and collected from the electrochemical cells 214 in parallel. However, uniformly distributing and collecting the fluids 32, 34, 36 may be challenging, especially at high current densities. Non-uniform distribution and collection of the fluids 32, 34, 36 may result in some of the electrochemical cells 214 having decreased performance or efficiency. The performance of some of the electrochemical cells 214 may be so low that the electrochemical system 210 is forced to shut down to prevent or minimize damage to the electrochemical stack 214S.

Performance of the electrochemical stack 214S and maximum current density are limited by the weaker electrochemical cell 214 that is starved of reactant 32, 34 or coolant 36 because lower reactant stoichiometries enhance kinetic (for example, oxygen reduction is a first order reaction), ohmic (membrane dehydration caused by limited product water or water reactant feed rate), and mass transfer losses. Additionally, reduced heat rejection may lead to electrochemical cell 214 overheating. A non-uniform flow distribution may also lead to localized failures (flooding, hotspots) that can affect neighboring electrochemical cells 214 as well as the flow distribution in the other reactant compartments. In extreme cases, non-uniformities may damage electrochemical cells 214 (fuel starvation in fuel cells and water starvation in electrolyzer cells). Fuel or water starvation may lead to reversal of the electrochemical cell 214 in which current is forced through the electrochemical cell 214, but the electrochemical cell 214 has insufficient fuel such that, for example, carbon in the catalyst is oxidized. This may result in damage to the electrochemical cell 214, which may necessitate replacement of the electrochemical cell 214.

Typically, the electrochemical cells 214 farther away from the inlet ports 216, 256, 258 receive less fluid 32, 34, 36 than the electrochemical cells 214 closer to the inlet ports 216, 256, 258. In ideal situations, a uniform distribution of the fluids 32, 34, 36 is delivered to each of the electrochemical cells 214.

As previously mentioned, the issues stemming from non-uniform flow distribution are heightened when the electrochemical system 210 operates at a higher current density. Higher current densities are often desirable as less electrochemical cells 214 are needed to provide the same amount of power. Thus, the size of the electrochemical stack 214S may be decreased and costs may be saved. High current densities in electrochemical stacks 214S comprising fuel cells may range from about 2 A/cm² to about 5 A/cm², including any range or specific number therein. High current densities in electrochemical stacks 214S comprising electrolyzer cells may range from about 2 A/cm² to about 20 A/cm², including any range or specific number therein. However, because the issues stemming from non-uniform flow distribution are heightened when the electrochemical system 210 operates at a higher current density, it is important to provide a more uniform flow distribution.

The manifold insert 212 uniformizes the fluid 32, 34, 36 flow distributions to each of the electrochemical cells 214. The manifold insert 212 is positioned in one or more of the continuous inlet manifolds 240, 242, 244 or the continuous outlet manifolds 246, 248, 250 during stack assembly, as shown in FIGS. 7 and 8. The manifold insert 212 modulates the pressure distribution in the continuous inlet manifold 240, 242, 244 or the continuous outlet manifolds 246, 248, 250, resulting in a more even cell to cell flow distribution.

The manifold insert 212 may be positioned in any one of or any combination of the continuous inlet manifolds 240, 242, 244 and/or the continuous outlet manifolds 246, 248, 250. In some embodiments, the electrochemical system 210 includes a plurality of manifold inserts 212 so that multiple of the continuous inlet manifolds 240, 242, 244 and/or the continuous outlet manifolds 246, 248, 250 includes a manifold insert 212 therein. As an example, as shown in FIGS. 7 and 8, one manifold insert 212 is positioned in the continuous inlet manifold 242 and another manifold insert 212 is positioned in the continuous outlet manifold 248. The manifold inserts 212 may be the same, or the manifold inserts 212 may be different (i.e., a different shape, a different size, a different permeability, a different orientation, etc.).

The manifold inserts 212 are removably positioned in the continuous inlet manifold 242 and the continuous outlet manifold 248 such that the manifold inserts 212 may be removed and replaced, as suggested in FIG. 7. Further, the manifold inserts 212 are compatible with preexisting electrochemical stacks 214S such that modification of the preexisting electrochemical stacks 214S is not needed. Instead of modifying the components of the electrochemical stacks 214S, which may result in increased cost and increased labor for assembly, the manifold insert 212 provides the beneficial modification. Additionally, different manifold inserts 212 may be used in the same electrochemical stack 214S allowing for a tailored approach to flow distribution based on the specific electrochemical stack 214S.

As shown in FIGS. 7 and 8, the second manifold 230 of each of the MEA 218 and the bipolar plates 224, 226 is aligned with one another to form the second continuous inlet manifold 242. The manifold insert 212 is inserted into the second continuous inlet manifold 242. The manifold insert 212 provides flow resistance for the oxidant 34 in the second continuous inlet manifold 242 thereby producing a more uniform flow distribution to the oxidant flow fields 225 of the bipolar plates 224, 226 of each of the plurality of electrochemical cells 214.

In some embodiments, the manifold insert 212 is wedge shaped, as shown in FIGS. 7 and 8. The manifold insert 212 varies an area of the second continuous inlet manifold 242 as the second continuous inlet manifold 242 extends from the first terminal end 242A to the second terminal end 242B.

The manifold insert 212 has a first height H1 at a first end 212A of the manifold insert 212, and a second height H2 at a second end 212B of the manifold insert 212, as shown in FIG. 7. In some embodiments, the first height H1 is greater than the second height H2. In some embodiments, the height of the manifold insert 212 decreases linearly from the first end 212A to the second end 212B thereof. In some embodiments, the height of the manifold insert 212 decreases non-linearly from the first end 212A to the second end 212B thereof. In some embodiments, a portion of the manifold insert 212 has a constant height.

In some embodiments, the manifold insert 212 is positioned in the second continuous inlet manifold 242 such that the first end 212A of the manifold insert 212 is adjacent the second inlet port 256 and the second end 212B is adjacent the second endplate 254. In this way, in some embodiments, the manifold insert 212 varies the area of the second continuous inlet manifold 242 so that the area increases as the second continuous inlet manifold 242 extends from the first terminal end 242A to the second terminal end 242B of the second continuous inlet manifold 242. The first height H1 of the manifold insert 212 at the second inlet port 256 results in more uniform distribution of the oxidant 34 to each of the plurality of electrochemical cells 214 as more oxidant 34 is directed toward the electrochemical cells 214 that are farther away from the second inlet port 256.

Generally, nothing impedes the flow of the fluids 32, 34, 36 within the continuous inlet manifolds 240, 242, 244 and the continuous outlet manifolds 246, 248, 250. With the added manifold insert 212, the manifold insert 212 acts as a barrier to provide restriction to the flow of the fluids 32, 34, 36. The flow resistance causes more uniform flow distribution to all of the electrochemical cells 214.

Though shown as a wedge shape having a linearly decreasing height, it will be understood that any shape with any variable height may be used. The manifold insert 212 may be tailored to the electrochemical stack 214S to achieve the desired flow distribution. For example, in some electrochemical stacks 214S, more flow may be desirable in the middle of the electrochemical stack 214S. As another example, if there is a known location of fuel starvation, more flow may be directed to that location to prevent or minimize fuel starvation. Further, the desired flow distribution may depend on the particular electrochemical stack 214S, the type of electrochemical cell 214, the application of the electrochemical stack 214S (stationary, mobile, space, etc.), the properties of the fluids 32, 34, 36, the phase of the fluids 32, 34, 36, whether the fluid 32, 34, 36 is recirculated, among other factors.

As shown in FIGS. 7 and 8, another manifold insert 212 is removably positioned in the second continuous outlet manifold 248. In some embodiments, the manifold insert 212 is positioned in the second continuous outlet manifold 248 such that the first end 212A of the manifold insert 212 is adjacent the second outlet port 262 and the second end 212B is adjacent the second endplate 254. In this way, in some embodiments, the manifold insert 212 varies the area of the second continuous outlet manifold 248 so that the area decreases as the second continuous outlet manifold 248 extends from the first terminal end 248A to the second terminal end 248B.

In some embodiments, for the oxidant 34, only one manifold insert 212 is located in the second continuous inlet manifold 242. In other embodiments, for the oxidant 34, one manifold insert 212 is located in the second continuous inlet manifold 242 and another manifold insert 212 is located in the second continuous outlet manifold 248, as shown in FIG. 8. The two manifold inserts 212 may be the same or different. Using two manifold inserts 212 for the oxidant 34 allows the flow distribution to be more finely tuned.

As an example, because the second continuous inlet manifold 242 includes the oxidant 34 therein (i.e., a gas) and the second continuous outlet manifold 248 includes the oxidant 34 and water therein (i.e., a gas and a liquid), two different manifold inserts 212 may be beneficial as the flow properties of the gas verses the gas and the liquid will differ.

As shown in FIGS. 7 and 8, in some embodiments, the manifold insert 212 may have a length that is less than that of the electrochemical stack 214S or the second continuous inlet manifold 242. In other embodiments, the manifold insert 212 may have a length that is substantially equal to or greater than that of the electrochemical stack 214S or the second continuous inlet manifold 242. During compression of the components of the electrochemical stack 214S, thicknesses of some of the components may be reduced (due to compression of the components). This effect may be considered when determining the length of the manifold insert 212.

The electrochemical system 210 may include any number of manifold inserts 212. The manifold inserts 212 may be located in any one of or combination of the continuous inlet manifolds 240, 242, 244 or the continuous outlet manifolds 246, 248, 250. The description of the manifold insert 212 related to the second continuous inlet and outlet manifolds 242, 248 apply to the description of the manifold insert 212 related to the other continuous inlet manifolds 240, 244 and the other continuous outlet manifolds 246, 250.

For example, a manifold insert 212 may be located in the first continuous inlet manifold 240 and/or the first continuous outlet manifold 246. The manifold inserts 212 provide flow resistance for the fuel 32 in the first continuous inlet manifold 240 and/or the first continuous outlet manifold 246 thereby producing a more uniform flow distribution to the fuel flow fields 227 of the bipolar plates 224, 226 of each of the plurality of electrochemical cells 214.

In some embodiments, the manifold insert 212 is positioned in the first continuous inlet manifold 240 such that the first end 212A of the manifold insert 212 is adjacent the first inlet port 216 and the second end 212B is adjacent the second endplate 254. In this way, in some embodiments, the manifold insert 212 varies the area of the first continuous inlet manifold 240 so that the area increases as the first continuous inlet manifold 240 extends from the first terminal end 240A to the second terminal end 240B. The first height H1 of the manifold insert 212 at the first inlet port 216 results in more uniform distribution of the fuel 32 to each of the plurality of electrochemical cells 214 as more fuel 32 is directed toward the electrochemical cells 214 that are farther away from the first inlet port 216.

In some embodiments, a manifold insert 212 is removably positioned in the first continuous outlet manifold 246. In some embodiments, the manifold insert 212 is positioned in the first continuous outlet manifold 246 such that the first end 212A of the manifold insert 212 is adjacent the first outlet port 260 and the second end 212B is adjacent the second endplate 254. In this way, in some embodiments, the manifold insert 212 varies the area of the first continuous outlet manifold 246 so that the area decreases as the first continuous outlet manifold 246 extends from the first terminal end 246A to the second terminal end 246B.

In some embodiments, for the fuel 32, only one manifold insert 212 is located in the first continuous inlet manifold 240. In other embodiments, for the fuel 32, one manifold insert 212 is located in the first continuous inlet manifold 240 and another manifold insert 212 is located in the first continuous outlet manifold 246. The two manifold inserts 212 may be the same or different. Using two manifold inserts 212 for the fuel 32 allows the flow distribution to be more finely tuned.

As another example, a manifold insert 212 may be located in the third continuous inlet manifold 244 and/or the third continuous outlet manifold 250. The manifold inserts 212 provide flow resistance for the cooling liquid 36 in the third continuous inlet manifold 244 and/or the third continuous outlet manifold 250 thereby producing a more uniform flow distribution to the coolant flow fields 229 of the bipolar plates 224, 226 of each of the plurality of electrochemical cells 214.

In some embodiments, the manifold insert 212 is positioned in the third continuous inlet manifold 244 such that the first end 212A of the manifold insert 212 is adjacent the third inlet port 258 and the second end 212B is adjacent the second endplate 254. In this way, in some embodiments, the manifold insert 212 varies the area of the third continuous inlet manifold 244 so that the area increases as the third continuous inlet manifold 244 extends from the first terminal end 244A to the second terminal end 244B. The first height H1 of the manifold insert 212 at the third inlet port 258 results in more uniform distribution of the cooling liquid 36 to each of the plurality of electrochemical cells 214 as more cooling liquid 36 is directed toward the electrochemical cells 214 that are farther away from the third inlet port 258.

In some embodiments, a manifold insert 212 is removably positioned in the third continuous outlet manifold 250. In some embodiments, the manifold insert 212 is positioned in the third continuous outlet manifold 250 such that the first end 212A of the manifold insert 212 is adjacent the third outlet port 264 and the second end 212B is adjacent the second endplate 254. In this way, in some embodiments, the manifold insert 212 varies the area of the third continuous outlet manifold 250 so that the area decreases as the third continuous outlet manifold 250 extends from the first terminal end 250A to the second terminal end 250B.

In some embodiments, for the cooling liquid 36, only one manifold insert 212 is located in the third continuous inlet manifold 244. In other embodiments, for the cooling liquid 36, one manifold insert 212 is located in the third continuous inlet manifold 244 and another manifold insert 212 is located in the third continuous outlet manifold 250. The two manifold inserts 212 may be the same or different. Using two manifold inserts 212 for the cooling liquid 36 allows the flow distribution to be more finely tuned. For cooling liquid 36, one manifold insert 212 may be sufficient as the cooling liquid 36 is in the liquid phase in both the continuous inlet and outlet manifolds 244, 250.

During assembly of the electrochemical stack 214S, the manifold insert 212 may be used for alignment of the electrochemical cells 214 and/or the components of the electrochemical cells 214. Because the manifold insert 212 extends through one of the manifolds 228, 230, 232, 234, 236, 238 of each of the components of the electrochemical cells 214, the manifold insert 212 may be used to ensure proper alignment of the components during assembly.

The manifold insert 212 may be secured to components of the electrochemical stack 214S, such as one of the endplates 252, 254, to avoid movement during stack operation. The manifold insert 212 may be secured to components via a tight fit, screws, or any other suitable method.

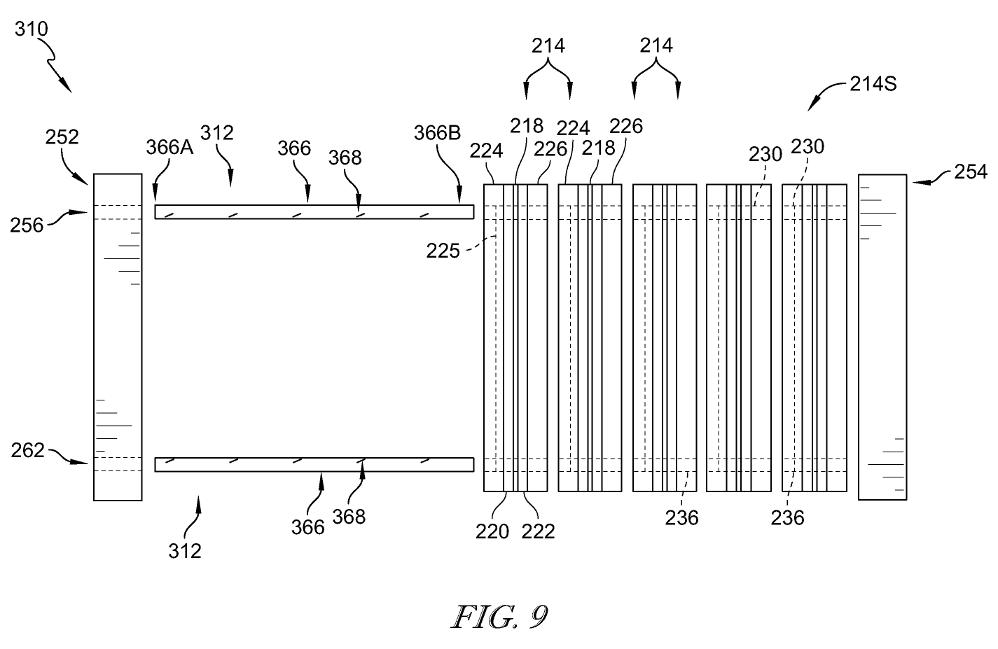

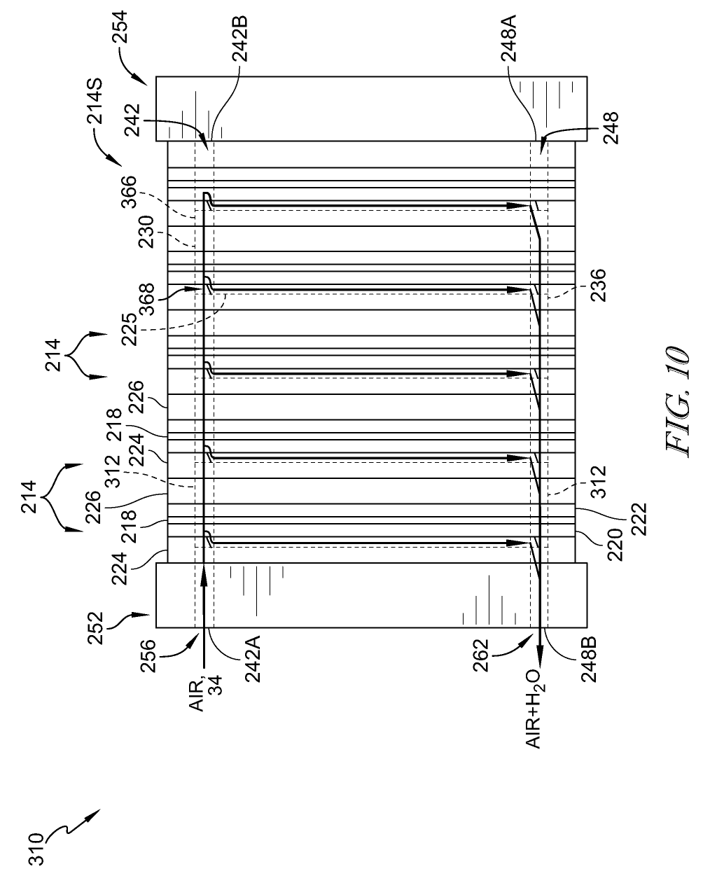

The present disclosure provides alternative manifold inserts 312 for use with an electrochemical system 310. FIGS. 9 and 10 illustrate another embodiment of the manifold insert 312 that is substantially similar to the manifold insert 212. In the absence of disclosure to the contrary, the features and components of the manifold insert 212 are applicable and present for the manifold insert 312.

The manifold insert 312 uniformizes the fluid 32, 34, 36 flow distributions to each of the electrochemical cells 214. The manifold insert 312 is positioned in one or more of the continuous inlet manifolds 240, 242, 244 and/or the continuous outlet manifolds 246, 248, 250 during stack assembly. The manifold insert 312 modulates the pressure distribution in the continuous inlet manifold 240, 242, 244 and/or the continuous outlet manifolds 246, 248, 250, resulting in a more even cell to cell flow distribution.

The manifold insert 312 may be positioned in any one of or any combination of the continuous inlet manifolds 240, 242, 244 and/or the continuous outlet manifolds 246, 248, 250. In some embodiments, the electrochemical system 310 includes a plurality of manifold inserts 312 so that multiple of the continuous inlet manifolds 240, 242, 244 and/or the continuous outlet manifolds 246, 248, 250 includes a manifold insert 312 therein. As an example, as shown in FIGS. 9 and 10, one manifold insert 312 is positioned in the continuous inlet manifold 242 and another manifold insert 312 is positioned in the continuous outlet manifold 248. The manifold inserts 312 may be the same, or the manifold inserts 312 may be different (i.e., a different shape, a different size, a different permeability, a different orientation, etc.).

The manifold inserts 312 are removably positioned in the continuous inlet manifold 242 and the continuous outlet manifold 248 such that the manifold inserts 312 may be removed and replaced, as suggested in FIG. 9. The manifold insert 312 provides flow resistance for the oxidant 34 in the second continuous inlet manifold 242 or the second continuous outlet manifold 248 thereby producing a more uniform flow distribution to the oxidant flow fields 225 of the bipolar plates 224, 226 of each of the plurality of electrochemical cells 214.

In some embodiments, the manifold insert 312 includes a frame 366 and a plurality of baffles 368, as shown in FIGS. 9 and 10. The frame 366 is positioned in the second continuous inlet manifold 242 or the second continuous outlet manifold 248. The plurality of baffles 368 are coupled to the frame 366 in spaced apart relation to one another. In some embodiments, each of the plurality of baffles 368 is spaced equally from one another, as shown in FIG. 9. In some embodiments, each of the plurality of baffles 368 is not spaced equally from one another. In other words, in some embodiments, a distance between baffles 368 may vary as the frame 366 extends between a first end 366A thereof and a second end 366B thereof. In some embodiments, the baffles 368 may be closer together near the first end 366A of the frame 366 and farther apart near the second end 366B of the frame 366. The baffles 368 being closer together near the first end 366A of the frame 366 provides more flow resistance near the second inlet port 256.

The baffles 368 deflect the flow of the oxidant 34 away from the oxidant flow fields 225, as shown in FIG. 10, before the oxidant 34 flows into the oxidant flow fields 225. In this way, the baffles 368 affect the flow distribution by locally influencing the pressure distribution and flow patterns. The baffles 368 may vary in size, orientation, or location along the frame 366. In some embodiments, the baffles 368 may be porous.

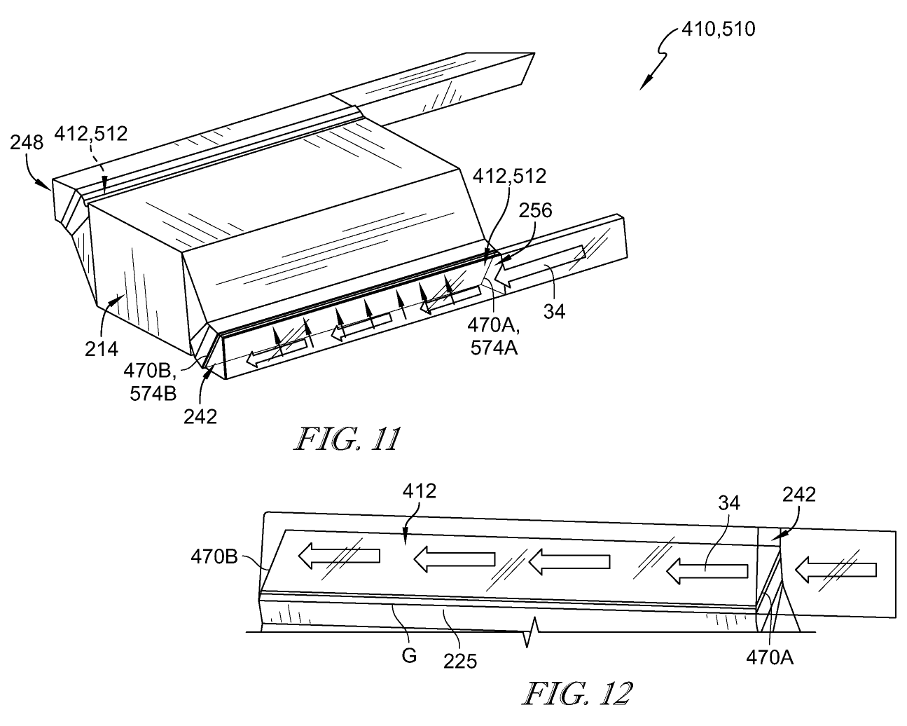

The present disclosure provides alternative manifold inserts 412 for use with an electrochemical system 410. FIGS. 11-13 illustrate another embodiment of the manifold insert 412 that is substantially similar to the manifold insert 212 and the manifold insert 312. In the absence of disclosure to the contrary, the features and components of the manifold insert 212 and the manifold insert 312 are applicable and present for the manifold insert 412.

The manifold insert 412 uniformizes the fluid 32, 34, 36 flow distributions to each of the electrochemical cells 214. The manifold insert 412 is positioned in one of or a combination of the continuous inlet manifolds 240, 242, 244 and/or the continuous outlet manifolds 246, 248, 250 during stack assembly. The manifold insert 412 modulates the pressure distribution in the continuous inlet manifold 240, 242, 244 and/or the continuous outlet manifolds 246, 248, 250, resulting in a more even cell to cell flow distribution.

The manifold insert 412 may be positioned in any one of the continuous inlet manifolds 240, 242, 244 and/or the continuous outlet manifolds 246, 248, 250. In some embodiments, the electrochemical system 410 includes a plurality of manifold inserts 412 so that multiple of the continuous inlet manifolds 240, 242, 244 and/or the continuous outlet manifolds 246, 248, 250 includes a manifold insert 412 therein. As an example, as shown in FIG. 11, one manifold insert 412 is positioned in the continuous inlet manifold 242. In some embodiments, another manifold insert 412 is positioned in the continuous outlet manifold 248. The manifold inserts 412 may be the same, or the manifold inserts 412 may be different (i.e., a different shape, a different size, a different permeability, a different orientation, etc.).

The manifold inserts 412 are removably positioned in the continuous inlet manifold 242 and the continuous outlet manifold 248 such that the manifold inserts 412 may be removed and replaced. The manifold insert 412 provides flow resistance for the oxidant 34 in the second continuous inlet manifold 242 and/or the second continuous outlet manifold 248 thereby producing a more uniform flow distribution to the oxidant flow fields 225 of the bipolar plates 224, 226 of each of the plurality of electrochemical cells 214.

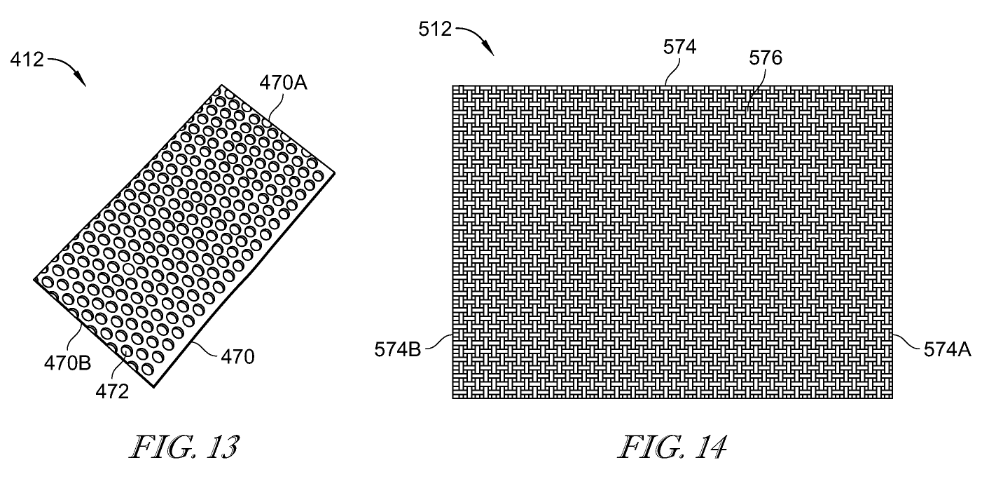

In some embodiments, the manifold insert 412 includes a plate 470 having a plurality of holes 472 formed therein, as shown in FIG. 13. In some embodiments, the plate 470 is substantially flat and/or planar. The plurality of holes 472 extend entirely through the plate 470. The holes 472 may have any shape or size. In some embodiments, the plurality of holes 472 are evenly distributed along a length of the plate 470. In some embodiments, the plurality of holes 472 are unevenly distributed along the length of the plate 470. For example, the plate 470 may have variable permeability along the length of the plate 470 due to the number and/or size of the plurality of holes 472. In some embodiments, a size of the plurality of holes 472 is variable along the length of the plate 470. In some embodiments, a number of holes 472 per unit area is variable along the length of the plate 470.

The oxidant 34 enters the second continuous inlet manifold 242 via the second inlet port 256, as suggested in FIG. 11. The oxidant 34 passes through the plurality of holes 472 and then into the oxidant flow fields 225. The plate 470 acts as a flow resistance element to the oxidant 34. The flow resistance may be varied by altering the hole 472 size or the hole 472 density, which either increases or decreases the amount of flow of the oxidant 34 that locally enters the corresponding oxidant flow field 225.

In one example, the plate 470 may have a lower permeability near a first end 470A thereof and a higher permeability near a second end 470B thereof. In some embodiments, the first end 470A of the plate 470 may be adjacent the second inlet port 256 so that there is more flow resistance near the second inlet port 256, as shown in FIG. 11. The permeability of the plate 470 may increase as the plate 470 extends from the first end 470A to the second end 470B thereof.

In some embodiments, the plate 470 extends parallel to an axis extending through the continuous inlet manifold 240, 242, 244 and/or the continuous outlet manifold 246, 248, 250, as shown in FIG. 11. In some embodiments, the plate 470 extends at an angle relative to the axis extending through the continuous inlet manifold 240, 242, 244 and/or the continuous outlet manifold 246, 248, 250. The plate 470 is positioned adjacent the oxidant flow fields 225 to form a gap G between the plate 470 and the oxidant flow fields 225. In some embodiments, the gap G is about 1 millimeter to about 1 centimeter, including any specific number or range of numbers comprised therein. The relatively small gap G ensures that there is minimal redistribution of the oxidant 34 before the oxidant 34 enters the oxidant flow fields 225.

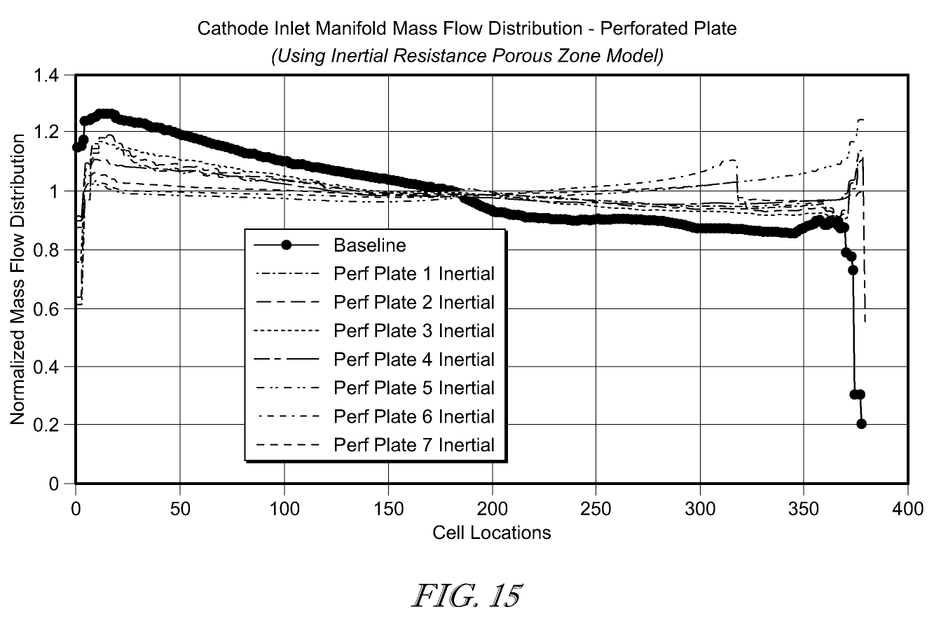

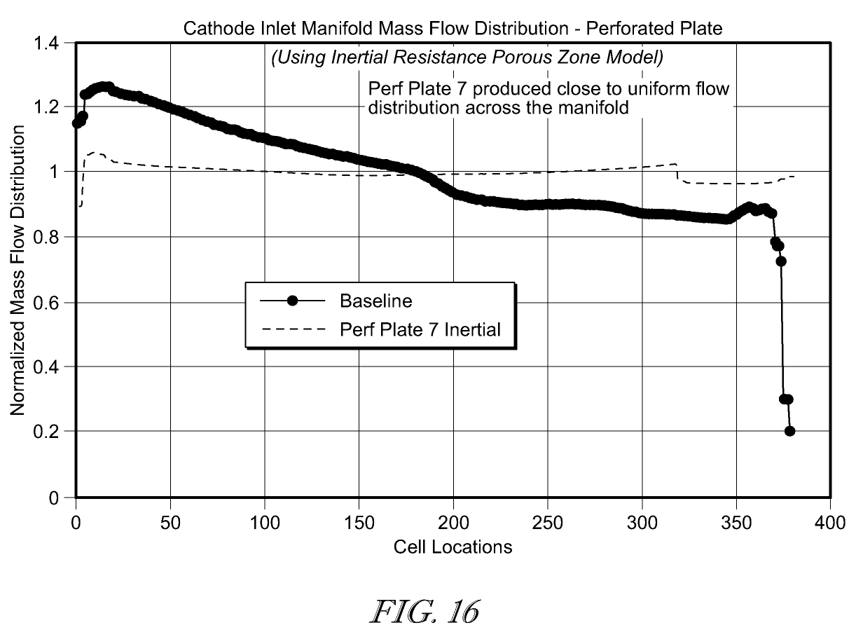

FIG. 15 shows a graph of fluid dynamics models of a fuel cell cathode plate stack having various manifold inserts 412 in the continuous inlet manifolds 242. The flow distribution corresponding to different manifold inserts 412 are shown and compared to a baseline case (having no manifold insert 412). The permeability of each of the manifold inserts 412 was varied lengthwise. The flow profile of the manifold insert 412 labeled as Plate 7, which produces the most optimal flow profile, is more clearly shown in FIG. 16. The manifold insert 412 labeled as Plate 7 produces a substantially flat flow distribution among the electrochemical cells 214 of the electrochemical stack 214S, as shown in FIG. 16, as compared to the baseline case having no manifold insert 412. A piecewise linearly varying inertial flow resistance for a certain distance and a constant inertial resistance was used for the manifold inserts 412 to produce the relatively flat flow distribution profiles. By changing the inertial flow resistance of the manifold insert 412, the flow distribution may be tailored to specific applications.

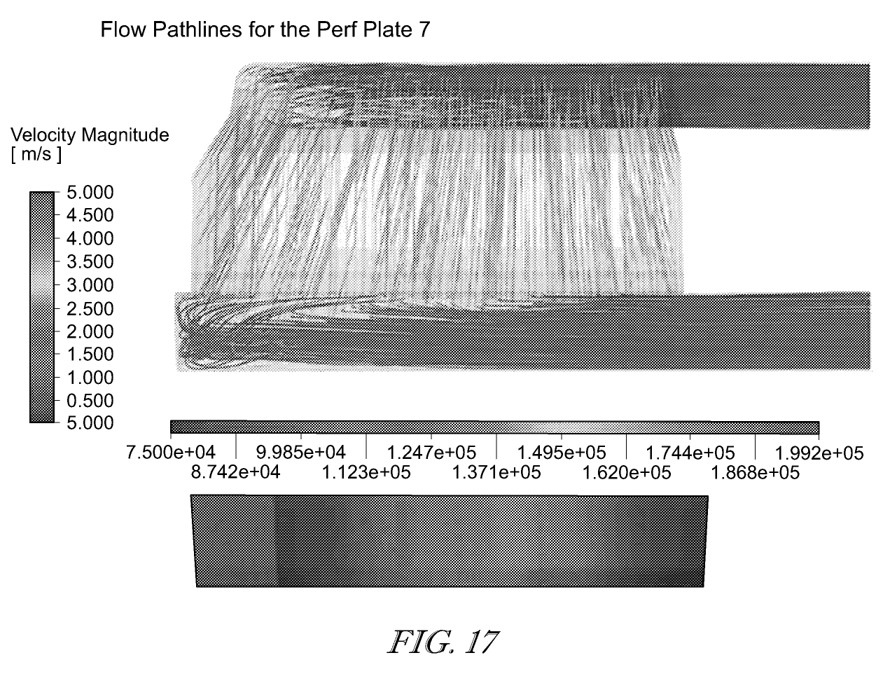

The flow non-uniformity at the opposing ends of the electrochemical stack 214S (near cell location 0 and cell location 375 of FIGS. 15 and 16) may be mitigated by using two different inertial resistance profiles. This may be achieved by using different holes 472 per unit area or different sized holes 472 at different locations along the length of the plate 470. A buffer region between two different inertial flow resistance regions in which the flow resistance changes more slowly may also be used. FIG. 17 shows flow path lines and the permeability distribution of the manifold insert 412 labeled as Plate 7 in FIG. 16.

The present disclosure provides alternative manifold inserts 512 for use with an electrochemical system 510. FIGS. 11 and 14 illustrate another embodiment of the manifold insert 512 that is substantially similar to the manifold insert 212, the manifold insert 312, and the manifold insert 412. In the absence of disclosure to the contrary, the features and components of the manifold insert 212, the manifold insert 312, and the manifold insert 412 are applicable and present for the manifold insert 512.

The manifold insert 512 uniformizes the fluid 32, 34, 36 flow distributions to each of the electrochemical cells 214. The manifold insert 512 is positioned in one of or a combination of the continuous inlet manifolds 240, 242, 244 and/or the continuous outlet manifolds 246, 248, 250 during stack assembly, as suggested in FIG. 11. The manifold insert 512 modulates the pressure distribution in the continuous inlet manifold 240, 242, 244 and/or the continuous outlet manifolds 246, 248, 250, resulting in a more even cell to cell flow distribution.

The manifold insert 512 may be positioned in any one of the continuous inlet manifolds 240, 242, 244 and/or the continuous outlet manifolds 246, 248, 250, as shown in FIG. 11. In some embodiments, the electrochemical system 510 includes a plurality of manifold inserts 512 so that multiple of the continuous inlet manifolds 240, 242, 244 and/or the continuous outlet manifolds 246, 248, 250 includes a manifold insert 512 therein. As an example, as shown in FIG. 11, one manifold insert 512 is positioned in the continuous inlet manifold 242. In some embodiments, another manifold insert 512 is positioned in the continuous outlet manifold 248. The manifold inserts 512 may be the same, or the manifold inserts 512 may be different (i.e., a different shape, a different size, a different permeability, a different orientation, etc.).

The manifold inserts 512 are removably positioned in the continuous inlet manifold 242 and the continuous outlet manifold 248 such that the manifold inserts 512 may be removed and replaced. The manifold insert 512 provides flow resistance for the oxidant 34 in the second continuous inlet manifold 242 or the second continuous outlet manifold 248 thereby producing a more uniform flow distribution to the oxidant flow fields 225 of the bipolar plates 224, 226 of each of the plurality of electrochemical cells 214.

In some embodiments, the manifold insert 512 includes a porous screen 574, as shown in FIG. 14. In some embodiments, the porous screen 574 is substantially flat and/or planar. The porous screen 574 is porous and/or permeable due to woven fibers forming a plurality of pores 576. The porous screen 574 may comprise woven plastic, woven metal wires, fibrous non-woven material, foam, a porous membrane, a porous sintered metal, etc.

In some embodiments, the permeability of the porous screen 574 is uniform along a length of the porous screen 574. In some embodiments, the permeability of the porous screen 574 is non-uniform along a length of the porous screen 574. For example, the porous screen 574 may have variable permeability along the length of the porous screen 574 due to the number and/or size of the plurality of pores 576. In some embodiments, a size of the plurality of pores 576 is variable along the length of the porous screen 574. In some embodiments, a number of pores 576 per unit area is variable along the length of the porous screen 574.

In one example, the porous screen 574 may have a lower permeability near a first end 574A thereof and a higher permeability near a second end 574B thereof, as shown in FIG. 11. In some embodiments, the first end 574A of the porous screen 574 may be adjacent the second inlet port 256 so that there is more flow resistance near the second inlet port 256. The permeability of the porous screen 574 may increase as the porous screen 574 extends from the first end 574A to the second end 574B thereof.

The oxidant 34 enters the second continuous inlet manifold 242 via the second inlet port 256, as suggested in FIG. 11. The oxidant 34 passes through the plurality of pores 576 and then into the oxidant flow fields 225. The porous screen 574 acts as a flow resistance element. The flow resistance may be varied by altering the pore 576 size or the pore 576 density, which either increases or decreases the amount of flow of the oxidant 34 that locally enters the corresponding oxidant flow field 225.

In some embodiments, the porous screen 574 extends parallel to an axis extending through the continuous inlet manifold 240, 242, 244 and/or the continuous outlet manifold 246, 248, 250, as shown in FIG. 11. In some embodiments, the porous screen 574 extends at an angle relative to the axis extending through the continuous inlet manifold 240, 242, 244 and/or the continuous outlet manifold 246, 248, 250. The porous screen 574 is positioned adjacent the oxidant flow fields 225 to form a gap between the porous screen 574 and the oxidant flow fields 225. In some embodiments, the gap is about 1 millimeter to about 1 centimeter, including any specific number or range of numbers comprised therein. The relatively small gap ensures that there is minimal redistribution of the oxidant 34 before the oxidant 34 enters the oxidant flow fields 225.

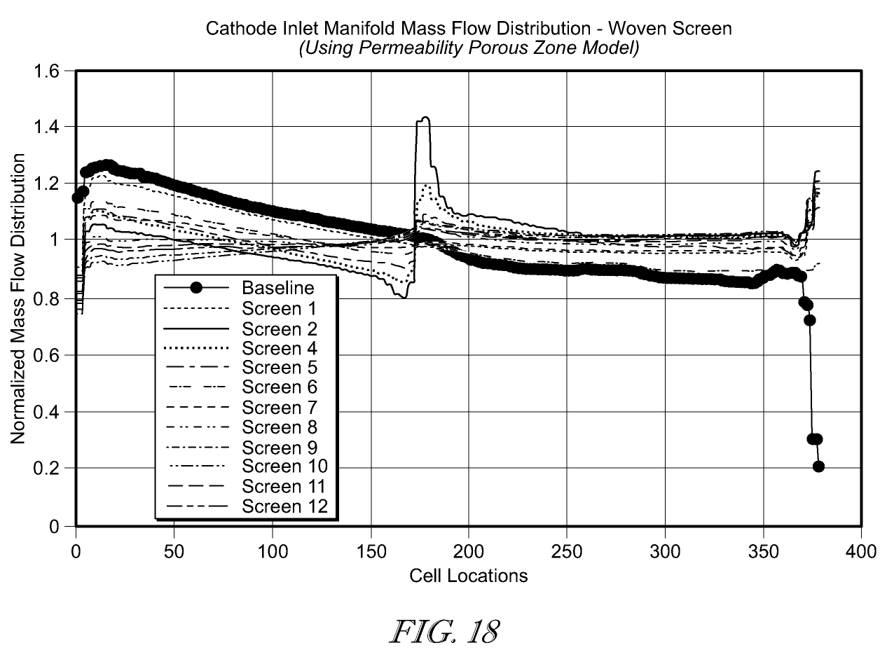

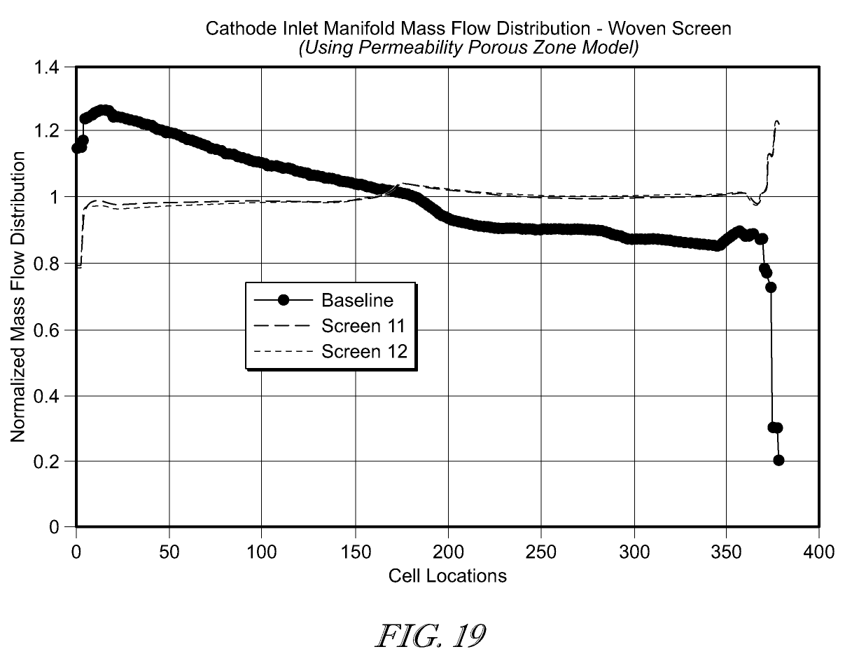

FIG. 18 shows a graph of fluid dynamics models of a fuel cell cathode plate stack having various manifold inserts 512 in the continuous inlet manifolds 242. The flow distribution corresponding to different manifold inserts 512 are shown and compared to a baseline case (having no manifold insert 512). The permeability of each of the manifold inserts 512 was varied lengthwise. The flow profile of manifold inserts 512 labeled as Screen 11 and Screen 12, which produce the most optimal flow profile, are more clearly shown in FIG. 19. Manifold inserts 512 labeled as Screen 11 and Screen 12 produce a substantially flat flow distribution among electrochemical cells 214 of the electrochemical stack 214S, as shown in FIG. 19.

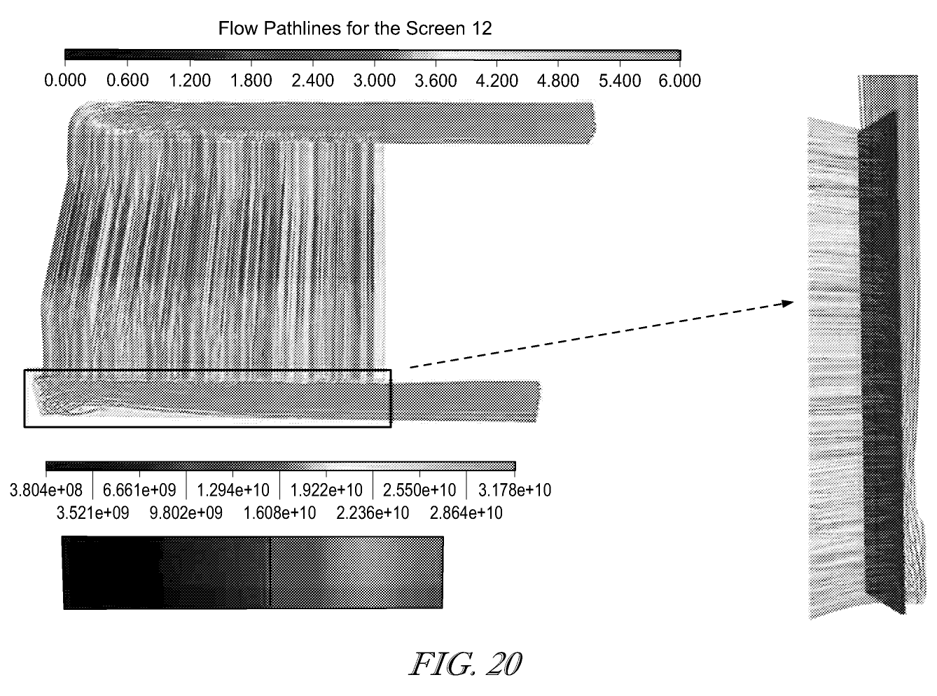

FIG. 20 shows flow path lines and the permeability distribution of the manifold insert 512 labeled as Screen 12 in FIG. 19. Two distinct piecewise continuous linearly varying permeability profiles may be used to produce the types of flow distribution profiles seen in FIGS. 18-20. Desired flow distribution profiles may be obtained by either using a continuously varying permeability profile or through many piecewise continuous flow profiles.

The manifold inserts 212, 312, 412, 512 minimize design complexity as the manifold inserts 212, 312, 412, 512 avoid the need for multiple bipolar plate 224, 226 and MEA 218 designs. The manifold inserts 212, 312, 412, 512 may be combined for increased effectiveness. For example, the manifold insert 212 and the manifold insert 512 may be arranged in one of the continuous inlet manifolds 240, 242, 244 and/or the continuous outlet manifolds 246, 248, 250. As another example, the manifold insert 212 may be arranged in one of the continuous inlet manifolds 240, 242, 244 and the manifold insert 512 may be arranged in one of the continuous outlet manifolds 246, 248, 250.

A pressure drop may occur with the manifold inserts 212, 312, 412, 512 as flow work may need to be expended to pump the fluid 32, 34, 36, by either diverting the flow, flowing through a reduced cross section, or flowing through a porous component. In some embodiments, the pressure drop across the manifold insert 412 or the manifold insert 512 may be about 3 kPa to about 5 kPa, including any specific number of range of numbers comprised therein. The manifold insert 512 may have viscous resistance with pressure loss varying linearly with flow rate, and the manifold insert 412 may have inertial resistance with pressure loss varying quadratically with flow rate.

The manifold inserts 212, 312, 412, 512 may be used with gaseous, liquid, or two phase (gaseous/liquid) flows. The manifold inserts 212, 312 may be porous rather than solid, which may provide additional advantages such as mixing (for example, with hydrogen added to the recirculated stream). For the manifold inserts 412, 512, other characteristics may be varied, such as the thickness of the manifold inserts 412, 512 or the pore/hole size and distribution. The variable permeability may also be produced by stacking manifold inserts 412, 512 of different permeability and different lengths on top of each other.

In illustrative embodiments, the manifold insert 212, 312, 412, 512 is not electrically conductive so that electrical shorting between components is avoided. In some embodiments, the manifold insert 212 is hollow. In some embodiments, the manifold insert 212, 312, 412, 512 is formed of polymers, composites, or any other suitable materials. In some embodiments, the manifold insert 212, 312, 412, 512 may be formed of polymeric foam, ceramic foam, or any other suitable porous or permeable material. In some embodiments, the manifold insert 212, 312 may be permeable or porous.

For use cases in which the electrochemical stack 214S orientation with respect to a gravity field varies during operation, the manifold insert 212, 312, 412, 512 may take into account changes in liquid pooling for liquid and two phase flows (gaseous/liquid) to ensure a uniform distribution to all electrochemical cells 214.

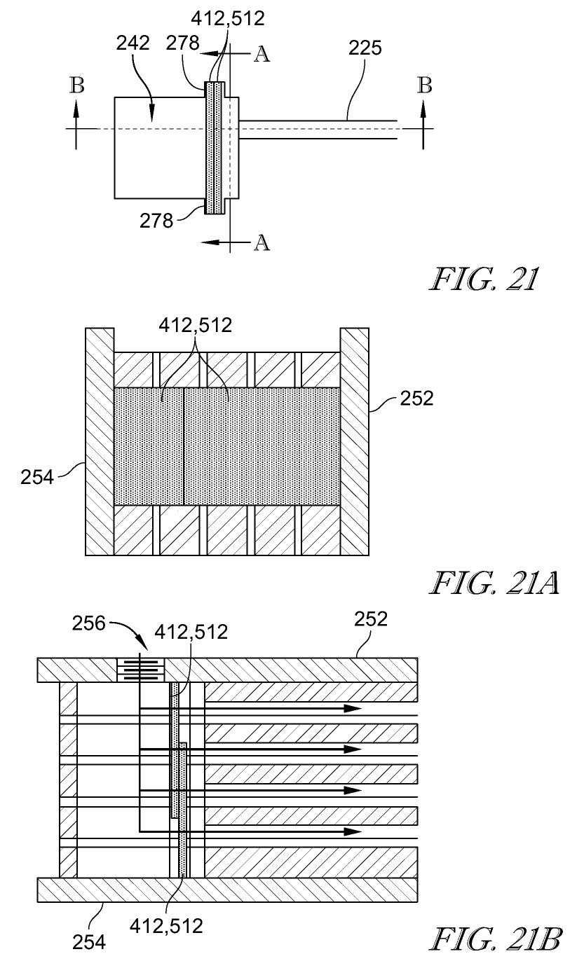

As previously described, during electrochemical stack 214S operation, the length of the continuous inlet manifolds 240, 242, 244 and/or the continuous outlet manifolds 246, 248, 250 may vary due to factors such as membrane swelling/contraction (water absorption/rejection) and/or seal compression set. As a result, it is beneficial if the length of the manifold insert 212, 312, 412, 512 passively accommodates changes in the length of the continuous inlet manifolds 240, 242, 244 and/or the continuous outlet manifolds 246, 248, 250. Thus, in some embodiments, two manifold inserts 212, 312, 412, 512 may be used in a single continuous inlet manifold 240, 242, 244 and/or continuous outlet manifold 246, 248, 250, as shown in FIGS. 21-21B. FIG. 21 shows a top view of the electrochemical stack 214S from a bipolar plate flow field channel plane. As shown in FIG. 21B, the two manifold insert 212, 312, 412, 512 overlap one another along a length of the continuous inlet manifold 242.

Two sides of the continuous inlet manifold 242 have notches 278 for insertion of the two manifold inserts 212, 312, 412, 512, as shown in FIG. 21. During stack assembly, one of the two manifold inserts 212, 312, 412, 512 is affixed to the endplate 254. Subsequently, bipolar plates 224, 226 and the MEA 218 are sequentially added. As a last step, the endplate 252, which also has an affixed manifold insert 212, 312, 412, 512, is set into place. The two manifold inserts 212, 312, 412, 512 have the same length, which is shorter than the length of the continuous inlet manifold 242. The overlap between the two manifold inserts 212, 312, 412, 512, which has a variable length, may be considered to ensure the flow distribution remains as uniform as possible. As an alternative, the manifold inserts 212, 312, 412, 512 may have more than two parts, which are secured together but free to move in the stack direction.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical, and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An electrochemical system comprising:
a plurality of electrochemical cells assembled together to form a stack, each of the plurality of electrochemical cells having a membrane, a first bipolar plate arranged on a first side of the membrane, and a second bipolar plate arranged on a second side of the membrane opposite the first side, each of the first and second bipolar plates formed to include a first manifold aligned with one another to define a first continuous inlet manifold in fluid communication with first flow fields of the first bipolar plate or the second bipolar plate,
a first inlet port configured to direct a first fluid into the first continuous inlet manifold, wherein the first continuous inlet manifold extends between a first terminal end at the first inlet port and a second terminal end opposite the first terminal end, and
a first manifold insert removably positioned in the first continuous inlet manifold to provide flow resistance for the first fluid in the first continuous inlet manifold thereby producing a more uniform flow distribution to the first flow fields of the first bipolar plate or the second bipolar plate of each of the plurality of electrochemical cells.

2. The electrochemical system of claim 1, wherein the first manifold insert varies an area of the first continuous inlet manifold as the first continuous inlet manifold extends from the first terminal end to the second terminal end.

3. The electrochemical system of claim 2, wherein the first inlet manifold is wedge shaped.

4. The electrochemical system of claim 3, wherein the area of the first continuous inlet manifold increases due to the first manifold insert as the first continuous inlet manifold extends from the first terminal end to the second terminal end.

5. The electrochemical system of claim 1, wherein each of the first and second bipolar plates is further formed to include a second manifold aligned with one another to define a second continuous inlet manifold in fluid communication with second flow fields of the first bipolar plate or the second bipolar plate, and wherein the electrochemical system further includes:
a second inlet port configured to direct a second fluid into the second continuous inlet manifold, wherein the second continuous inlet manifold extends between a first terminal end at the second inlet port and a second terminal end opposite the first terminal end, and
a second manifold insert removably positioned in the second continuous inlet manifold to provide flow resistance for the second fluid in the second continuous inlet manifold thereby producing a more uniform flow distribution to the second flow fields of the first bipolar plate or the second bipolar plate of each of the plurality of electrochemical cells.

6. The electrochemical system of claim 1, wherein the first manifold insert includes a frame and a plurality of baffles coupled to the frame in spaced apart relation to one another, and wherein the plurality of baffles deflect flow of the first fluid away from the first flow fields before the first fluid is directed into the first flow fields.

7. The electrochemical system of claim 1, wherein the first manifold insert includes a plate having a plurality of holes formed therein, and wherein a permeability of the plate varies as the first continuous inlet manifold extends from the first terminal end to the second terminal end.

8. The electrochemical system of claim 7, wherein the permeability of the plate increases as the first continuous inlet manifold extends from the first terminal end to the second terminal end.

9. The electrochemical system of claim 1, wherein the first manifold insert includes a woven screen having a plurality of pores formed therein, and wherein a permeability of the woven screen varies as the first continuous inlet manifold extends from the first terminal end to the second terminal end.

10. An electrochemical system comprising:
a plurality of electrochemical cells assembled together to form a stack, each of the plurality of electrochemical cells having a first manifold aligned with the first manifold of adjacent electrochemical cells to define a first continuous inlet manifold in fluid communication with first flow fields of each of the plurality of electrochemical cells,
a first inlet port configured to direct a first fluid into the first continuous inlet manifold, and
a first manifold insert removably positioned in the first continuous inlet manifold to provide flow resistance for the first fluid in the first continuous inlet manifold thereby producing a more uniform flow distribution to the first flow fields of each of the plurality of electrochemical cells.

11. The electrochemical system of claim 10, wherein the first continuous inlet manifold extends between a first terminal end at the first inlet port and a second terminal end opposite the first terminal end, and wherein the first manifold insert varies an area of the first continuous inlet manifold as the first continuous inlet manifold extends from the first terminal end to the second terminal end.

12. The electrochemical system of claim 11, wherein the first inlet manifold is wedge shaped so as to have a first height adjacent the first terminal end and a second height adjacent the second terminal end, the first height being greater than the second height.

13. The electrochemical system of claim 10, wherein the first manifold insert includes a frame and a plurality of baffles coupled to the frame in spaced apart relation to one another, and wherein the plurality of baffles deflect flow of the first fluid away from the first flow fields before the first fluid is directed into the first flow fields.

14. The electrochemical system of claim 10, wherein the first continuous inlet manifold extends between a first terminal end at the first inlet port and a second terminal end opposite the first terminal end, and wherein the first manifold insert includes a plate having a plurality of holes formed therein, and wherein a permeability of the plate varies as the first continuous inlet manifold extends from the first terminal end to the second terminal end.

15. The electrochemical system of claim 10, wherein the first continuous inlet manifold extends between a first terminal end at the first inlet port and a second terminal end opposite the first terminal end, and wherein the first manifold insert includes a woven screen having a plurality of pores formed therein, and wherein a permeability of the woven screen varies as the first continuous inlet manifold extends from the first terminal end to the second terminal end.

16. A method comprising:
stacking a plurality of electrochemical cells adjacent one another such that a first manifold of each of the plurality of electrochemical cells is aligned with one another to form a first continuous inlet manifold,
inserting a manifold insert into the first continuous inlet manifold,
directing fluid into the first continuous inlet manifold from an inlet port, and
variably restricting flow of the fluid within the first continuous inlet manifold via the manifold insert to cause uniform distribution of the fluid to each of the plurality of electrochemical cells.

17. The method of claim 16, further comprising removing the manifold insert from the first continuous inlet manifold, and, after the step of removing, inserting a different manifold insert into the first continuous inlet manifold.

18. The method of claim 16, wherein the step of variably restricting flow includes having a first flow resistance adjacent the inlet port and having a second flow resistance opposite the inlet port, the second flow resistance being less than the first flow resistance.

19. The method of claim 16, wherein the step of stacking includes aligning a second manifold of each of the plurality of electrochemical cells with one another to form a second continuous outlet manifold, and wherein the method further comprises directing the fluid through the first continuous inlet manifold, through the plurality of electrochemical cells, and then into the second continuous outlet manifold.

20. The method of claim 19, further comprising inserting a second manifold insert into the second continuous outlet manifold.
